(19) United States
(12) Patent Application Publication
(10) Pub. No.: US 2025/0388995 A1
(43) Pub. Date: Dec. 25, 2025

(54) SYSTEMS AND METHODS FOR RECYCLING END-OF-LIFE BATTERY MATERIALS

(71) Applicant: 24M Technologies, Inc., Cambridge, MA (US)

(72) Inventors: Matthew Blake SCHWARTZ, Somerville, MA (US); Xiaoming LIU, Newton, MA (US); Liufeng XIONG, Lexington, MA (US); Junhua SONG, Sudbury, MA (US); Alyssa Marie STAVOLA, Wrentham, MA (US); Benjamin Joseph HERTZBERG, Cambridge, MA (US); Junzheng CHEN, Concord, MA (US)

(21) Appl. No.: 19/233,438

(22) Filed: Jun. 10, 2025

Related U.S. Application Data
(60) Provisional application No. 63/662,802, filed on Jun. 21, 2024.

(51) Int. Cl. C22B 7/00; C22B 26/12; H01M 10/54

(52) U.S. Cl. CPC C22B 7/007; C22B 26/12; H01M 10/54

(57) ABSTRACT

Embodiments described herein relate to systems and methods for recycling spent batteries. In some aspects, a method of recycling battery materials can include separating an anode material from a first cathode material and a first separator of a spent electrochemical cell. The method further includes washing the anode material, and drying the anode material to form a recycled anode material, and combining the recycled anode material with a second cathode material and a second separator material to form a recycled electrochemical cell. The method can optionally include washing the first cathode material, drying the first cathode material to form a cathode powder; and regenerating the cathode powder to form a regenerated cathode material, and combining the regenerated cathode material with a second anode material and a second separator to form a recycled electrochemical cell.

### CROSS-REFERENCE TO RELATED APPLICATIONS

This application claims priority to and the benefit of U.S. Provisional Application No. 63/662,802, filed Jun. 21, 2024, and entitled “Systems and Methods for Recycling End-of-Life Battery Materials,” the entire disclosure of which is hereby incorporated by reference herein.

### TECHNICAL FIELD

Embodiments described herein relate to electrochemical cells and recycling methods thereof.

### BACKGROUND

Lithium-ion batteries (LIBs) have been widely used for portable electronics and electric vehicle applications, due to their high energy density and long cycle life. The production of LIBs is projected to reach ˜440 GWh by 2025 with a market value of ˜$100 billion. It is expected that a large amount of LIBs will be retired in the near future since the typical lifespan of a LIB is about 3 to 10 years. Current commercial recycling methods focus on extracting metal elements from cathode materials via hydrometallurgical and pyrometallurgical processes. Recycling graphite anode materials is not common due to low profit margins with current state-of-the-art recycling methods. As a result, end-of-life (EOL) graphite anodes have historically been burned or disposed of in landfills. This results in large amounts of greenhouse gas emissions and inefficient use of materials that are still viable for energy storage. Additionally, the growth of the electric vehicle market has and will continue to create a large demand for graphite, resulting in an increase in graphite cost. Improved processing of electrode materials can improve the economic viability of such cells.

### SUMMARY

Embodiments described herein relate to systems and methods for recycling spent batteries. In some aspects, a method of recycling End-of-Life (EOL) battery materials can include separating an anode material from a first cathode material, and a first separator of a spent electrochemical cell. The method further includes washing the anode material, drying the anode material to form a recycled anode material, and combining the recycled anode material with a second cathode material and a second separator material to form a recycled electrochemical cell. In some embodiments, the anode material can include a carbon-based anode material. In some embodiments, the carbon-based anode material can include at least one of: mesocarbon microbeads, artificial graphite, natural graphite, or hard carbon. In some embodiments, the anode material can include a non-carbon-based anode material. In some embodiments, the non-carbon-based anode material may include silicon, tin, SiO, SiO₂ antimony, lithium metal, TiO₂, lithium titanate (LTO), Sn, Sb, SnO₂, SnS, SnS₂, Sn₃P₄, Bi, P, Sb₂O₃, Fe₂O₃, Al, Ag, Au, B, Mg, and/or In. In some embodiments, the second cathode material may itself be a recycled cathode material.

In some aspects, a method of recycling battery materials can include separating cathode material from a first anode material, and a first separator of a spent electrochemical cell. This method further includes washing the cathode material, drying the cathode material to form a cathode powder; and regenerating the cathode powder to form a regenerated cathode material. In some embodiments, the method may further include combining the regenerated cathode material with a second anode material and a second separator to form a recycled electrochemical cell. In some embodiments, the second anode material may itself be a recycled anode material.

In some aspects, a method of forming a recycled electrochemical cell can include separating a first anode material and a first cathode material from a first separator, the first anode material, first cathode material, and the first separator being included in a first electrochemical cell. The method includes exposing a second electrochemical cell and/or the first anode material to at least one of a leaching solvent or a lithium removal solvent to form a lithium-rich liquid. The method further includes separating the second electrochemical cell and/or the first anode material from the lithium-rich liquid and mixing lithium metal from the lithium-rich liquid with the first cathode material to form a regenerated cathode material. The method further includes washing the first anode material, drying the first anode material to form a recycled anode material, and combining the recycled anode material with the regenerated cathode material and a second separator to form a recycled electrochemical cell.

### BRIEF DESCRIPTION OF THE DRAWINGS

FIG. 1A is a flow diagram of a method of recycling an anode material from a spent battery, according to an embodiment.

FIG. 1B illustrates a process for surface treatment of recycled anode material, according to an embodiment.

FIG. 2 is a flow diagram of a method of recycling a cathode material from a spent battery, according to an embodiment.

FIG. 3 is a flow diagram of a method of recycling a spent battery, according to an embodiment.

FIG. 4 is a block diagram of a system for recovering and recycling components of an electrochemical cell, according to an embodiment.

FIG. 5 is a graphical comparison of the particle size distributions of pristine anode powder as compared to recycled anode powder.

FIGS. 6A-6B show structure characterization via x-ray diffraction (XRD) of pristine anode powder, as compared to recycled anode powder.

FIGS. 7A-7E show morphology and compositions of recycled anode materials via scanning electron microscopy (SEM) and energy dispersive x-ray spectroscopy (EDS).

FIGS. 8A-8C show graphical comparisons of capacity and coulombic efficiency of electrochemical cells with recycled and pristine anode materials.

FIG. 9 is a graphical comparison of the particle size distributions of pristine anode powder as compared to recycled anode powder.

FIGS. 10A-10B show recycled anode powder, as compared to pristine anode powder, as viewed via SEM.

FIG. 11 is a graphical comparison of specific capacities of electrochemical cells with pristine anode materials and recycled anode materials.

FIG. 12 shows XRD comparisons of EOL lithium iron phosphate (LFP) electrodes compared to pristine LFP electrodes and relithiated LFP electrodes.

FIGS. 13A-13C show SEM images of EOL LFP, pristine LFP, and relithiated LFP.

FIG. 14 is a graphical representation of a first cycle voltage profile of EOL LFP vs. pristine LFP.

FIGS. 15A-15B show first cycle voltage profiles and capacity of relithiated LFP and pristine LFP.

FIG. 16 shows XRD comparison of pristine graphite anode material, EOL graphite anode material, recycled anode material after washing and heat treatment, and recycled anode material after washing, heat treatment, and pitch coating.

FIGS. 17A-17B show SEM images of recycled anode material after heat treatment with and without pitch coating.

FIG. 18 shows XRD results for pristine LFP, EOL LFP, recycled LFP before heat treatment, LFP with heat treatment at 600° C. without lithium salt, LFP with heat treatment at 600° C. with 2% Li₂CO₃, LFP with heat treatment at 600°° C. with 3% Li₂CO₃, and LFP with heat treatment at 600°° C. with 4% Li₂CO₃.

FIG. 19 is a graphical representation of effect of heat treatment and Li₂CO₃ percentage on anti-sites.

FIG. 20 shows XRD results for Pristine LFP, EOL LFP, relithiated LFP with malic acid (MA), and repeat of relithiated LFP with malic acid (MA).

FIG. 21 is a graphical representation of first cycle voltage profiles and specific capacity of relithiated LFP with MA and pristine LFP.

FIGS. 22A-22B are graphical representations of discharge capacity (mAh/g) and discharge capacity percentage (%) relative to cycle number for pristine and relithiated LFP with MA at C/3 rate (discharge rate) and room temperature, respectively.

FIGS. 23A-23B show XRD results for pristine lithium cobalt oxide cathode (LCO), EOL LCO, solution relithiated LCO, solution relithiated LCO with heat treatment (at 850° C. for 5 hours in oxygen), and solid state relithiated LCO (at 850° C. for 10 hours in oxygen).

FIG. 24 is a graphical representation of first cycle voltage profiles of pristine LCO, EOL LCO, and recycled LCO.

FIGS. 25A-25B show XRD results for pristine nickel manganese cobalt oxide (NMC), EOL NMC, solution relithiated NMC, solution relithiated NMC after heat treatment (at 750° C. for 5 hours).

### DETAILED DESCRIPTION

Previous anode recycling processes have included the application of strong acids (e.g., HCl, H₂SO₄) followed by high temperature annealing to remove an anode solid electrolyte interface (SEI) and regenerate anodes from EOL batteries. The use of such caustic acids can create environmental and pollution problems as well as significant costs. In addition, to remove anode binder, separation processes (e.g., soaking, washing, filtration, and/or centrifugation) are often used, further increasing operation costs. Furthermore, some EOL anodes include polyvinylidene fluoride (PVDF) binder, and PVDF residue left after the removal process can decompose during annealing steps. The decomposed binder can produce fluorine impurities, leading to degraded cell performance.

Embodiments described herein include environmentally benign, sustainable, and low-cost methods of recycling EOL anode materials and cathode materials from electrochemical cells. In some embodiments, the anode materials and/or the cathode materials can be included in semi-solid electrodes. In some embodiments described herein, anode materials from EOL cells can be regenerated via a series of steps that include discharging EOL cells, separating anode powder from the other components of anodes, washing and collecting the anode powder, drying the powder, removing the residual lithium from the anode powder. In some embodiments, the method can include surface modification of the anode powder.

Capacity degradation of LIBs is primarily attributed to loss of lithium inventory with structural changes. Such losses can result from the formation of the SEI on the anode particles, chemical destruction of the cathode materials, and/or mechanical failure from repeated volume changes in both electrodes. Morphology and bulk structure of anode materials are often maintained making it possible to regenerate anode materials via surface washing and drying processes. Additionally, after washing and drying anode powder, spent lithium residue can be removed to further improve recycled anode performance. Post treatment (e.g., surface modification followed by annealing) can improve the performance of the anode by forming a more stable SEI.

In some aspects, methods of regenerating spent anode material of LIBs can include separating the anode material (e.g., anode powder) from the rest of the spent anode materials via ultrasonication, washing the anode material with organic solvents and/or deionized water, and filtering (e.g., via a Buchner funnel and/or centrifuge) the anode material. The method can further include drying the anode material at a temperature of about 60° C. to about 80° C. for about 10 to about 14 hours in ambient air and about 80° C. to about 250° C. for about 10 hours to about 14 hours under vacuum. In some embodiments, the anode material may be free or substantially free of binder. This may simplify the process and reduce the cost of processing. In this case, the process may not require a binder-dissolution process to separate the anode material from anode electrodes. In the case of anodes with PVDF binder, toxic solvents such as N-methyl-2-pyrrolidone (NMP) may be used to dissolve PVDF binder and separate anode material from substrate, which may further increasing the cost of processing.

In some embodiments, spent lithium residue may be removed via a lithium extraction process using lithium removal agents. In some embodiments, the lithium removal agents can include biphenyl, naphthalene, 2-methyl biphenyl, 3,3′-dimethyl biphenyl, 4,4′-dimethyl biphenyl, 3,3′,4,4′-tetramethyl biphenyl and/or other molecules with a strong electron affinity that conjugates with electron donating alkaline metals (e.g., lithium, sodium) to form negatively charged radicals. The lithium removal agents can be dispersed in organic solvents including, but not limited to dimethyl carbonate (DMC), dimethyl ether (DME), tetrahydrofuran (THF), methyl acetate (MA), ethyl acetate (EA), ethyl methyl carbonate (EMC), diethyl carbonate (DEC), acetonitrile (ACN), isopropyl alcohol (IPA), and/or N-methylpyrrolidone (NMP).or any combination thereof. Such lithium residue removal processes do not use harsh acid washes (e.g., via H₂SO₄, HCl), which can cause secondary pollution or environmental concerns. In some embodiments, the spent lithium residue may be removed via leaching without the use of organic chemicals, for example, removed using a sodium persulfate solution.

In some embodiments, post treatment of anode materials (e.g., anode powders) via surface modifications may be carried out to improve anode performance. Annealing may also be performed to improve anode performance. In some embodiments, surface modifiers may include boron, titanium, tungsten oxides, carbon, or any combination thereof. Such modifiers can improve anode performance by modifying anode surface SEI properties or blocking the active edge site of graphite from exposure to electrolyte. The surface modification process may include mixing precursors of a surface modifier with anode materials and heating the mixture at a high temperature to decompose the precursors.

Binder-free anodes from semi-solid electrodes provide an opportunity to simplify the anode material separation process and reduce the recycling cost. In addition, a residual lithium removal process without caustic acid provides a greener and more efficient route for sustainable recycling of spent LIB anodes. For example, lithium removal can be conducted via molecules with a strong electron affinity that conjugate with an electron donating alkaline metal (e.g., Li, Na).

In some embodiments, electrodes described herein can include conventional solid electrodes. In some embodiments, the solid electrodes can include binders. In some embodiments, electrodes described herein can include semi-solid electrodes. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes.

In some embodiments, the solid or semi-solid electrodes described herein may be binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can include a flowable semi-solid, condensed liquid, or slurry composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid electrodes are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference in their entirety.

Some embodiments described herein can include recycling systems and methods described in U.S. Pat. No. 10,411,310 (“the '310 patent”), filed Jun. 20, 2016, and titled, “Methods for Electrochemical Cell Remediation,” the disclosure of which is hereby incorporated by reference in its entirety. Some embodiments described herein can include recycling systems and methods described in U.S. Patent Publication No. 2023/0352755 (“the '755 publication”), filed Mar. 30, 2023, and titled “Systems and Methods for Electrochemical Cell Material Recycling,” the disclosure of which is hereby incorporated by reference in its entirety.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

As used herein, the terms “activated carbon network” and “networked carbon” relate to a general qualitative state of an electrode. For example, an electrode with an activated carbon network (or networked carbon) is such that the carbon particles within the electrode assume an individual particle morphology and arrangement with respect to each other that facilitates electrical contact and electrical conductivity between particles and through the thickness and length of the electrode. Conversely, the terms “unactivated carbon network” and “unnetworked carbon” relate to an electrode wherein the carbon particles either exist as individual particle islands or multi-particle agglomerate islands that may not be sufficiently connected to provide adequate electrical conduction through the electrode.

As used herein, the terms “energy density” and “volumetric energy density” refer to the amount of energy (e.g., MJ) stored in an electrochemical cell per unit volume (e.g., L), including the electrodes, the separator, the electrolyte, the current collectors, and cell packaging. Unless otherwise noted, energy density and volumetric density include cell packaging.

As used herein, “particle size” refers to an average diameter of a particle. In other words, “particle size” refers to the average distance across the particle through all imaginary lines passing through a volumetric center of the particle. For example, the particle size of a sphere is the sphere's diameter. The particle size of an irregular-shaped particle is the average distance through the particle among all imaginary lines passing through the particle.

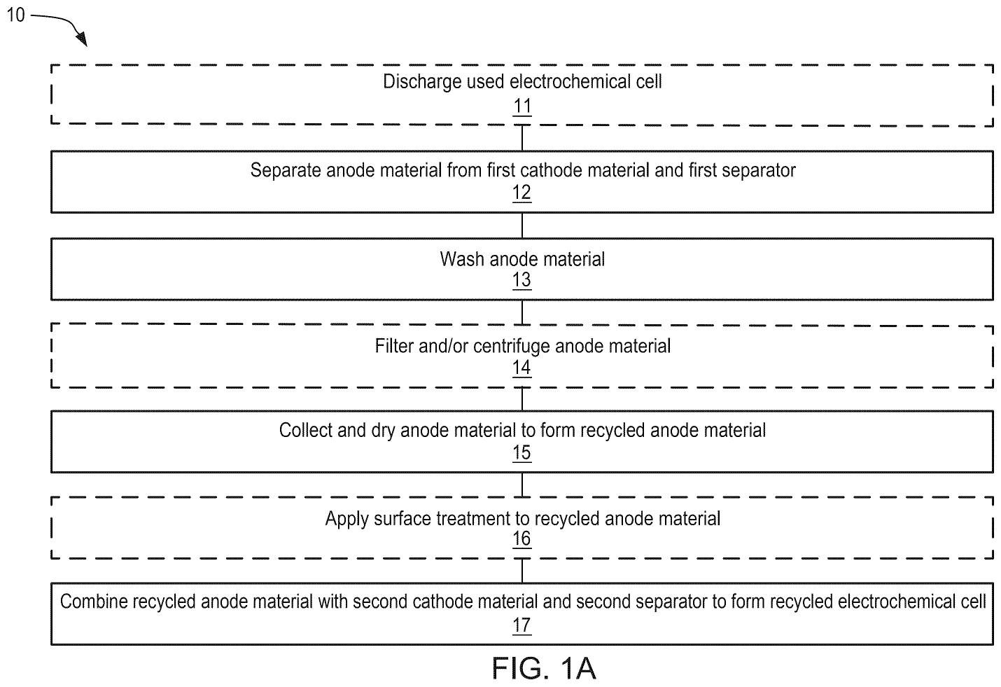

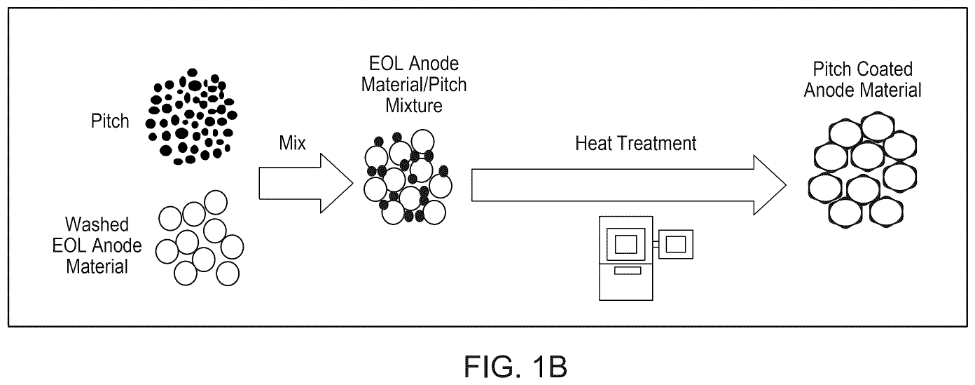

FIG. 1A is a flow diagram of a method 10 of recycling an anode material from a spent battery, according to an embodiment. As shown, the method 10 optionally includes discharging a used electrochemical cell at step 11. The method 10 includes separating an anode material from a first cathode material and a first separator (and optionally, any packaging material) at step 12 and washing the anode material at step 13. The method 10 optionally includes filtering and/or centrifuging the anode material at step 14. The method 10 includes collecting and drying the anode material to form a recycled anode material at step 15. The method 10 optionally includes applying a surface treatment to the recycled anode material at step 16. The method 10 further includes combining the recycled anode material with a second cathode material and a second separator to form a recycled electrochemical cell at step 17. Several of the steps are described with respect to anode processing, but can also apply to a cathode.

The “spent”, “depleted” or “used” nature of the electrochemical cell refers to an at least partial degradation or loss or gain of material such that at least one of its active materials is compositionally different from its state at the original assembly of the electrochemical cell. For example, due to the loss of cyclable lithium in a lithium ion battery, the stoichiometry of the cathode active material of the used electrochemical cell may be measurably different from that of the “fresh” cathode material of the electrochemical cell (i.e., there has been a shift in the relative quantities of its constituents).

In some embodiments, depleted (i.e., used) electrochemical cell can include substantially semi-depleted, partially depleted, or almost fully depleted electrode material.

Step 11 is optional and includes discharging a used electrochemical cell. The discharging process is a safety measure that can prevent involuntary electrode discharge during the recycling process. In some embodiments, the discharging can be to a state-of-charge (SOC) of less than about 30% SOC, less than about 25% SOC, less than about 20% SOC, less than about 15% SOC, less than about 10% SOC, less than about 9% SOC, less than about 8% SOC, less than about 7% SOC, less than about 6% SOC, less than about 5% SOC, less than about 4% SOC, less than about 3% SOC, less than about 2% SOC, less than about 1% SOC, less than about 0.9% SOC, less than about 0.8% SOC, less than about 0.7% SOC, less than about 0.6% SOC, less than about 0.5% SOC, less than about 0.4% SOC, less than about 0.3% SOC, less than about 0.2% SOC, or less than about 0.1% SOC.

In some embodiments, the used electrochemical cell can include a semi-solid anode. In some embodiments, the used electrochemical cell can include a semi-solid cathode. In some embodiments, the used electrochemical cell can include a conventional solid anode. In some embodiments, the used electrochemical cell can include a conventional solid cathode. In some embodiments, the used electrochemical cell can include an F3000 cell. In some embodiments, the electrochemical cell can have a capacity of at least about 1 Ah, at least about 5 Ah, at least about 6 Ah, at least about 10 Ah, at least about 20 Ah, at least about 30 Ah, at least about 40 Ah, at least about 50 Ah, at least about 60 Ah, at least about 70 Ah, at least about 80 Ah, at least about 90 Ah, at least about 100 Ah, at least about 500 Ah, at least about 1 kAh, at least about 5 kAh, at least about 10 kAh, at least about 50 kAh, at least about 100 kAh, or at least about 500 kAh. In some embodiments, the electrochemical cell can have a capacity of no more than about 1 MAh, no more than about 500 kAh, no more than about 100 kAh, no more than about 50 kAh, no more than about 10 kAh, no more than about 5 kAh, no more than about 1 kAh, no more than about 500 Ah, no more than about 100 Ah, no more than about 90 Ah, no more than about 80 Ah, no more than about 70 Ah, no more than about 60 Ah, no more than about 50 Ah, no more than about 40 Ah, no more than about 30 Ah, no more than about 20 Ah, no more than about 10 Ah, or no more than about 5 Ah. Combinations of the above-referenced capacities are also possible (e.g., at least about 1 Ah and no more than about 1 MAh or at least about 50 Ah and no more than about 100 kAh), inclusive of all values and ranges therebetween. In some embodiments, the electrochemical cell can have a capacity of about 1 Ah, about 5 Ah, about 6 Ah, about 10 Ah, about 20 Ah, about 30 Ah, about 40 Ah, about 50 Ah, about 60 Ah, about 70 Ah, about 80 Ah, about 90 Ah, about 100 Ah, about 500 Ah, about 1 kAh, about 5 kAh, about 10 kAh, about 50 kAh, about 100 kAh, about 500 kAh, or about 1 MAh.

Step 12 includes separating an anode material from a first cathode material and a first separator. In some embodiments, the separation of the anode material can be manual. In some embodiments, the anode material can be removed via scraping. In some embodiments, the anode material can be removed via ultrasonication. In some embodiments, the anode material can be soaked in a liquid prior to removal in order to make the removal process easier. In some embodiments, the anode material can be soaked in isopropyl alcohol. The absence of a binder in the anode material can allow for easier separation of the anode material from the separator (i.e., without any additional processing steps). In some embodiments, step 12 may also include separating the anode material from packaging material (e.g., casing, fillers, insulating layers, spacers, heaters, etc.) in addition to the first cathode material and the first separator.

Step 13 includes washing the anode material. The washing aids in removal of electrolyte salt and/or solvent from the anode material. In some embodiments, the washing can be via a single washing liquid. In some embodiments, the washing can be via multiple washing liquids. In some embodiments, the washing can be via an organic liquid. In some embodiments, the washing can be via an inorganic liquid. In some embodiments, the washing can be via a polar liquid. In some embodiments, the washing can be via a non-polar liquid. In some embodiments, the washing can be via dimethyl carbonate (DMC). In some embodiments, the washing can be via water. In some embodiments, the washing can include multiple washing steps, for example, a first washing step via DMC and a second washing step via water. In some embodiments, the washing can be via an organic solvent such as, for example, methyl acetate (MA), ethyl acetate (EA), ethyl methyl carbonate (EMC), diethyl carbonate (DEC, or acetonitrile (ACN), isopropyl alcohol (IPA), and/or N-methylpyrrolidone (NMP). In some embodiments, the washing can be via isopropyl alcohol or a mixture of isopropyl alcohol (IPA) and water (e.g., deionized water) having a IPA to water ratio of about 10:90 to about 90:10, inclusive (e.g., about 10:90; 15:85, 20:80, 25:75, 30:70, 35:65, 40:60, 45:55, 50:50, 55:45, 60:40, 65:35, 70:30, 75:25, 80:20, 85:15, or 90:10, inclusive).

Step 14 is optional and includes filtering and/or centrifuging the anode material. The combination of a centrifuge and a filter can create a cake, pellet, or other solid structure of the anode material with a low liquid content. In some embodiments, the cake pellet, or other solid structure of the anode material can have a liquid content of less than about 20 wt %, less than about 15 wt %, less than about 10 wt %, less than about 9 wt %, less than about 8 wt %, less than about 7 wt %, less than about 6 wt %, less than about 5 wt %, less than about 4 wt %, less than about 3 wt %, less than about 2 wt %, less than about 1 wt %, less than about 0.9 wt %, less than about 0.8 wt %, less than about 0.7 wt %, less than about 0.6 wt %, less than about 0.5 wt %, less than about 0.4 wt %, less than about 0.3 wt %, less than about 0.2 wt %, or less than about 0.1 wt %, inclusive of all values and ranges therebetween.

Step 15 includes collecting and drying the anode material (e.g., cake, pellet, or other solid structure of the anode material to form a recycled anode material. In some embodiments, the drying can include a first drying step and a second drying step. In some embodiments, the first drying step can be in air. In some embodiments, the second drying step can be under vacuum.

In some embodiments, the first drying step can be at a temperature of at least about 30° C., at least about 40° C., at least about 50° C., at least about 60° C., at least about 70° C., at least about 80° C., or at least about 90° C. In some embodiments, the first dying step can be at a temperature of no more than about 100° C., no more than about 90° C., no more than about 80° C., no more than about 70° C., no more than about 60° C., no more than about 50° C., or no more than about 40° C. Combinations of the above-referenced temperatures are also possible (e.g., at least about 30° C. and no more than about 100° C. or at least about 50° C. and no more than about 80° C.), inclusive of all values and ranges therebetween. In some embodiments, the first drying step can be at a temperature of about 30° C., about 40° C., about 50° C., about 60° C., about 70° C., about 80° C., about 90° C., or about 100° C.

In some embodiments, the first drying step can have a duration of at least about 1 minute, at least about 5 minutes, at least about 10 minutes, at least about 20 minutes, at least about 30 minutes, at least about 40 minutes, at least about 50 minutes, at least about 1 hour, at least about 2 hours, at least about 3 hours, at least about 4 hours, at least about 5 hours, at least about 6 hours, at least about 7 hours, at least about 8 hours, at least about 9 hours, at least about 10 hours, at least about 11 hours, at least about 12 hours, at least about 13 hours, at least about 14 hours, at least about 15 hours, at least about 16 hours, at least about 17 hours, at least about 18 hours, or at least about 19 hours. In some embodiments, the first drying step can have a duration of no more than about 20 hours, no more than about 19 hours, no more than about 18 hours, no more than about 17 hours, no more than about 16 hours, no more than about 15 hours, no more than about 14 hours, no more than about 13 hours, no more than about 12 hours, no more than about 11 hours, no more than about 10 hours, no more than about 9 hours, no more than about 8 hours, no more than about 7 hours, no more than about 6 hours, no more than about 5 hours, no more than about 4 hours, no more than about 3 hours, no more than about 2 hours, no more than about 1 hour, no more than about 50 minutes, no more than about 40 minutes, no more than about 30 minutes, no more than about 20 minutes, or no more than about 10 minutes. Combinations of the above-referenced durations are also possible (e.g., at least about 1 minute and no more than about 20 hours or at least about 30 minutes and no more than about 4 hours), inclusive of all values and ranges therebetween. In some embodiments, the first drying step can have a duration of about 1 minute, about 5 minutes, about 10 minutes, about 20 minutes, about 30 minutes, about 40 minutes, about 50 minutes, about 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, or about 20 hours.

In some embodiments, the second drying step can be at a temperature of at least about 80° C., at least about 90° C., at least about 100° C., at least about 110° C., at least about 120° C., at least about 130° C., at least about 140° C., at least about 150° C., at least about 160° C., at least about 170° C., at least about 180° C., at least about 190° C., at least about 200° C., at least about 220° C., at least about 240° C., or at least about 250° C. In some embodiments, the second drying step can be at a temperature of no more than about 260° C., no more than about 250° C., no more than about 240° C., no more than about 220° C., no more than about 200° C., no more than about 190° C., no more than about 180° C., no more than about 170° C., no more than about 160° C., no more than about 150° C., no more than about 140° C., no more than about 130° C., no more than about 120° C., no more than about 110° C., no more than about 100° C., or no more than about 90° C. Combinations of the above-referenced temperatures are also possible (e.g., at least about 80° C. and no more than about 250° C. or at least about 90° C. and no more than about 240° C.), inclusive of all values and ranges therebetween. In some embodiments, the second drying step can be at a temperature of about 80° C., about 90° C., about 100° C., about 110° C., about 120° C., about 130° C., about 140° C., about 150° C., about 160° C., about 170° C., about 180° C., about 190° C., about 200° C., about 210° C., about 220° C., about 230° C., about 240° C., or about 250° C.

In some embodiments, the second drying step can have a duration of at least about 6 hours, at least about 7 hours, at least about 8 hours, at least about 9 hours, at least about 10 hours, at least about 11 hours, at least about 12 hours, at least about 13 hours, at least about 14 hours, at least about 15 hours, at least about 16 hours, at least about 17 hours, at least about 18 hours, at least about 19 hours, at least about 20 hours, at least about 21 hours, at least about 22 hours, or at least about 23 hours. In some embodiments, the drying step can have a duration of no more than about 24 hours, no more than about 23 hours, no more than about 22 hours, no more than about 21 hours, no more than about 20 hours, no more than about 19 hours, no more than about 18 hours, no more than about 17 hours, no more than about 16 hours, no more than about 15 hours, no more than about 14 hours, no more than about 13 hours, no more than about 12 hours, no more than about 11 hours, no more than about 10 hours, no more than about 9 hours, no more than about 8 hours, or no more than about 7 hours. Combinations of the above-referenced durations are also possible (e.g., at least about 6 hours and no more than about 24 hours or at least about 8 hours and no more than about 20 hours), inclusive of all values and ranges therebetween. In some embodiments, the second drying step can have a duration of about 6 hours, about 7 hours, about 8hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, or about 24 hours.

Step 16 is optional and includes applying a surface treatment to the recycled anode material. In some embodiments, the surface treatment can include treating the anode material with a lithium removal agent to remove any residual lithium. In some embodiments, the lithium removal agent can be prepared by mixing organic solvent with biphenyl, naphthalene, 2-methyl biphenyl, 3,3′-dimethyl biphenyl, 4,4′-dimethyl biphenyl, 3,3′,4,4′-tetramethyl biphenyl and/or any other molecules with strong electron affinity that conjugate with electron donating alkaline metal. In some embodiments, the organic solvent can include DME, THE, or any combination thereof. In some embodiments, the dried anode material (i.e., powder) can be dispersed in the lithium removal agent by mixing. In some embodiments, step 16 can include an additional washing of the anode material (e.g., via DME and/or THF). In some embodiments, an additional drying step (i.e., the same or substantially similar to step 15) can be applied to the anode material after the lithium removal agent is applied. In some embodiments, the surface treatment process may include treating the anode material an acidic aqueous solution including a weak acid, for example, citric acid or acetic acid.

In some embodiments, the surface modification of step 16 can vary based on the surface treatment applied. For example, precursors of a surface modifier can be mixed with the anode powder and annealed at high temperatures to decompose the precursors and form a surface modified anode. In some embodiments, the surface modifier can include tungsten, titanium, boron, carbon, or any combination thereof. In some embodiments, the precursor of the surface modifier can include boric acid (H3BO3), an alkoxide (e.g., titanium isopropoxide, tungsten (VI) ethoxide) and/or pitch.

In some embodiments, the recycled anode powder can have a particle size distribution that differs from pristine anode powder. In some embodiments, the recycled anode powder can have a lower standard deviation than the pristine anode powder. In some embodiments, the anode powder can have a larger average particle size than pristine anode powder. In some embodiments, the anode powder can have a smaller average particle size than pristine anode powder. In some embodiments, the recycled anode powder can have a larger frequency distribution percentage (q-value) than the pristine anode powder. In some embodiments, the recycled anode powder can have a smaller q-value than the pristine anode powder.

In some embodiments, the recycled anode powder can have a mean particle size of at least about 10 μm, at least about 15 μm, at least about 20 μm, at least about 25 μm, at least about 30 μm, at least about 35 μm, at least about 40 μm, at least about 45 μm, at least about 50 μm, at least about 55 μm, at least about 60 μm, at least about 65 μm, at least about 70 μm, at least about 75 μm, at least about 80 μm, at least about 85 μm, at least about 90 μm, or at least about 95 μm. In some embodiments, the recycled anode powder can have a mean particle size of no more than about 100 μm, no more than about 95 μm, no more than about 90 μm, no more than about 85 μm, no more than about 80 μm, no more than about 75 μm, no more than about 70 μm, no more than about 65 μm, no more than about 60 μm, no more than about 55 μm, no more than about 50 μm, no more than about 45 μm, no more than about 40 μm, no more than about 35 μm, no more than about 30 μm, no more than about 25 μm, no more than about 20 μm, or no more than about 15 μm. Combinations of the above-referenced mean particle sizes are also possible (e.g., at least about 10 μm and no more than about 100 μm or at least about 30 μm and no more than about 70 μm), inclusive of all values and ranges therebetween. In some embodiments, the recycled anode powder can have a mean particle size of about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, or about 100 μm.

In some embodiments, the recycled anode powder can have a median particle size of at least about 10 μm, at least about 15 μm, at least about 20 μm, at least about 25 μm, at least about 30 μm, at least about 35 μm, at least about 40 μm, at least about 45 μm, at least about 50 μm, at least about 55 μm, at least about 60 μm, at least about 65 μm, at least about 70 μm, at least about 75 μm, at least about 80 μm, at least about 85 μm, at least about 90 μm, or at least about 95 μm. In some embodiments, the recycled anode powder can have a median particle size of no more than about 100 μm, no more than about 95 μm, no more than about 90 μm, no more than about 85 μm, no more than about 80 μm, no more than about 75 μm, no more than about 70 μm, no more than about 65 μm, no more than about 60 μm, no more than about 55 μm, no more than about 50 μm, no more than about 45 μm, no more than about 40 μm, no more than about 35 μm, no more than about 30 μm, no more than about 25 μm, no more than about 20 μm, or no more than about 15 μm. Combinations of the above-referenced median particle sizes are also possible (e.g., at least about 10 μm and no more than about 100 μm or at least about 30 μm and no more than about 70 μm), inclusive of all values and ranges therebetween. In some embodiments, the recycled anode powder can have a median particle size of about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, or about 100 μm.

In some embodiments, the standard deviation of the particle size of the recycled anode powder can be at least about 0.1 μm, at least about 0.2 μm, at least about 0.3 μm, at least about 0.4 μm, at least about 0.5 μm, at least about 0.6 μm, at least about 0.7 μm, at least about 0.8 μm, at least about 0.9 μm, at least about 1 μm, at least about 1.5 μm, at least about 2 μm, at least about 2.5 μm, at least about 3 μm, at least about 3.5 μm, at least about 4 μm, at least about 4.5 μm, at least about 5 μm, at least about 5.5 μm, at least about 6 μm, at least about 6.5 μm, at least about 7 μm, at least about 7.5 μm, at least about 8 μm, at least about 8.5 μm, at least about 9 μm, at least about 9.5 μm, at least about 10 μm, at least about 11 μm, at least about 12 μm, at least about 13 μm, at least about 14 μm, at least about 15 μm, at least about 16 μm, at least about 17 μm, at least about 18 μm, or at least about 19 μm. In some embodiments, the standard deviation of the particle size of the recycled anode powder can be no more than about 20 μm, no more than about 19 μm, no more than about 18 μm, no more than about 17 μm, no more than about 16 μm, no more than about 15 μm, no more than about 14 μm, no more than about 13 μm, no more than about 12 μm, no more than about 11 μm, no more than about 10 μm, no more than about 9.5 μm, no more than about 9 μm, no more than about 8.5 μm, no more than about 8 μm, no more than about 7.5 μm, no more than about 7 μm, no more than about 6.5 μm, no more than about 6 μm, no more than about 5.5 μm, no more than about 5 μm, no more than about 4.5 μm, no more than about 4 μm, no more than about 3.5 μm, no more than about 3 μm, no more than about 2.5 μm, no more than about 2 μm, no more than about 1.5 μm, no more than about 1 μm, no more than about 0.9 μm, no more than about 0.8 μm, no more than about 0.7 μm, no more than about 0.6 μm, no more than about 0.5 μm, no more than about 0.4 μm, no more than about 0.3 μm, or no more than about 0.2 μm. Combinations of the above-referenced standard deviations are also possible (e.g., at least about 0.1 um and no more than about 20 μm or at least about 1 μm and no more than about 10 μm), inclusive of all values and ranges therebetween. In some embodiments, the standard deviation of the particle size of the recycled anode powder can be about 0.1 μm, about 0.2 μm, about 0.3 μm, about 0.4μm, about 0.5 μm, about 0.6 μm, about 0.7 μm, about 0.8 μm, about 0.9 μm, about 1 μm, about 1.5 μm, about 2 μm, about 2.5 μm, about 3 μm, about 3.5 μm, about 4 μm, about 4.5 μm, about 5 μm, about 5.5 μm, about 6 μm, about 6.5 μm, about 7 μm, about 7.5 μm, about 8 μm, about 8.5 μm, about 9 μm, about 9.5 μm, about 10 μm, about 11 μm, about 12 μm, about 13 μm, about 14 μm, about 15 μm, about 16 μm, about 17 μm, about 18 μm, or about 19 μm, or about 20 μm.

In some embodiments, the particle size distribution of the recycled anode powder can have a q-value of at least about 8%, at least about 8.5%, at least about 9%, at least about 9.5%, at least about 10%, at least about 10.5%, at least about 11%, at least about 11.5%, at least about 12%, at least about 12.5%, at least about 13%, at least about 13.5%, at least about 14%, at least about 14.5%, at least about 15%, at least about 15.5%, at least about 16%, at least about 16.5%, at least about 17%, at least about 17.5%, at least about 18%, at least about 18.5%, at least about 19%, or at least about 19.5%. In some embodiments, the particle size distribution of the recycled anode powder can have a q-value of no more than about 20%, no more than about 19.5%, no more than about 19%, no more than about 18.5%, no more than about 18%, no more than about 17.5%, no more than about 17%, no more than about 16.5%, no more than about 16%, no more than about 15.5%, no more than about 15%, no more than about 14.5%, no more than about 14%, no more than about 13.5%, no more than about 13%, no more than about 12.5%, no more than about 12%, no more than about 11.5%, no more than about 11%, no more than about 10.5%, no more than about 10%, no more than about 9.5%, no more than about 9%, or no more than about 8.5%. Combinations of the above-referenced q-values are also possible (e.g., at least about 8% and no more than about 20% or at least about 10% and no more than about 18%), inclusive of all values and ranges therebetween. In some embodiments, the particle size distribution of the recycled anode powder can have a q-value of about 8%, about 8.5%, about 9%, about 9.5%, about 10%, about 10.5%, about 11%, about 11.5%, about 12%, about 12.5%, about 13%, about 13.5%, about 14%, about 14.5%, about 15%, about 15.5%, about 16%, about 16.5%, about 17%, about 17.5%, about 18%, about 18.5%, about 19%, about 19.5%, or about 20%.

In some embodiments, the recycled anode powder can have an interlayer spacing that differs from the interlayer spacing of pristine anode powder by less than about 5%, less than about 4%, less than about 3%, less than about 2%, less than about 1%, less than about 0.9%, less than about 0.8%, less than about 0.7%, less than about 0.6%, less than about 0.5%, less than about 0.4%, less than about 0.3%, or less than about 0.2% of the interlayer spacing of the pristine anode powder.

In some embodiments, the recycled anode powder can have an interlayer spacing of at least about 3.3 Å, at least about 3.31 Å, at least about 3.32 Å, at least about 3.33 Å, at least about 3.34 Å, at least about 3.35 Å, at least about 3.36 Å, at least about 3.37 Å, at least about 3.371 Å, at least about 3.372 Å, at least about 3.373 Å, at least about 3.374 Å, at least about 3.375 Å, at least about 3.376 Å, at least about 3.377 Å, at least about 3.378 Å, at least about 3.379 Å, at least about 3.38 Å, or at least about 3.39 Å. In some embodiments, the recycled anode powder can have an interlayer spacing of no more than about 4 Å, no more than about 3.9 Å, no more than about 3.8 Å, no more than about 3.379 Å, no more than about 3.378 Å, no more than about 3.377 Å, no more than about 3.376 Å, no more than about 3.375 Å, no more than about 3.374 Å, no more than about 3.373 Å, no more than about 3.372 Å, no more than about 3.371 Å, no more than about 3.37 Å, no more than about 3.36 Å, no more than about 3.35 Å, no more than about 3.34 Å, no more than about 3.33 Å, no more than about 3.32 Å, or no more than about 3.31 Å. Combinations of the above-referenced interlayer spacings are also possible (e.g., at least about 3.3 Å and no more than about 3.4 Å or at least about 3.32 Å and no more than about 3.38 Å), inclusive of all values and ranges therebetween. In some embodiments, the recycled anode powder can have an interlayer spacing of about 3.3 Å, about 3.31 Å, about 3.32 Å, about 3.33 Å, about 3.34 Å, about 3.35 Å, about 3.36 Å, about 3.37 Å, about 3.371 Å, about 3.372 Å, about 3.373 Å, about 3.374 Å, about 3.375 Å, about 3.376 Å, about 3.377 Å, about 3.378 Å, about 3.379 Å, about 3.38 Å, about 3.39 Å, or about 3.4 Å.

In some embodiments, applying surface treatment to the recycled anode material may include coating the recycled anode material with pitch (e.g., petroleum pitch). For example, FIG. 1B illustrates a process 16a for surface treatment of recycled anode material that may be used as the surface treatment process of operation 16 of method 10, according to an embodiment. The process 16a may include mixing pitch with washed EOL anode material, for example, the recycled anode material obtained at operation 16. The pitch may include coal tar pitch or petroleum pitch. Pitch is a viscoelastic polymer that can be natural or manufactured, derived from petroleμm, coal tar, or plants. Pitch produced from petroleum may include bitumen or asphalt, while plant-derived pitch, a resin, may include rosin in its solid form. In some embodiments, the pitch may include coal tar or pine tar.

In some embodiments, any carbon-rich material derived from distillation of coal tar or petroleum residues can be used for surface modification of recycled anode material. In some embodiments, the pitch may have a high carbon content that can provide high compatibility with the recycled anode material. In some embodiments, pitch coating can fill the microcracks and irregular surface of recycled anode material and improve surface conductivity and stability. In some embodiments, a softening point of pitch can be in range of about 80° C., about 100° C., about 110° C., about 120° C., about 130° C., about 140° C., about 150° C., about 160° C., about 170° C., about 180° C., about 190° C., about 200° C., about 210° C., about 220° C., about 230° C., about 240° C., or about 250° C. In some embodiments, the pitch can penetrate into pores and adhere to the surface of recycled anode material. In some embodiments, the pitch can improve wettability of recycled anode material, its mechanical strength and oxidation resistance. In some embodiments, the pitch can fill the microcracks, reduce the exposure of active sites towards electrolyte, and/or decrease the irreversible capacity loss of the anode material due to solid electrolyte interface (SEI) formation. In some embodiments, the various parameter utilized at operations 13, 14, and/or 15 of the method 10 can affect the quality of surface treatment with pitch.

In some embodiments, viscosity of pitch, and particle size for the recycled anode material can affect the coating quality. In some embodiments, the pitch to graphite ratio can affect the coating thickness. In some embodiments, the coating thickness can affect wettability of recycled anode material, its mechanical strength and oxidation resistance. The mixing of the pitch with the recycled anode material may be performed using any suitable mixer, for example, a mechanical mixer, a kneader, a homogenizer, a stirrer, any other suitable mixer, or any suitable combination thereof. For example, the pitch may be disposed (e.g., poured, sprayed, dropped, etc.) on the recycled anode material obtained at operation 15, and then mixed using any suitable mixer. The mixing may coat the recycled anode material, for example, particles of the recycled anode material that may be in powder form substantially homogenously or uniformly on the recycled anode material.

In some embodiments, the mixture of pitch and recycled anode material can be exposed to heat treatment to reduce the viscosity of pitch, to improve a quality of the pitch coating on the recycled anode material, and/or to solidify the pitch coating on the recycled anode material. In some embodiments heat treatment may be configured to cause calcination of the pitch on the recycled anode material, for example, thermal decomposition of the pitch constituent, and/or removal of volatile substances therefrom. In some embodiments, the heat treatment can lead to conversion of pitch into a carbon-rich conductive layer. In some embodiments, the heat treatment can be configured to anneal the coated pitch, for example, to reduce surface defects of the recycled anode material and decompose impurities.

The heat treatment (e.g., calcination) can be a single step or multistep process. In some embodiments, the heat treatment can be single step performed at a temperature of at least about 200° C., at least about 210° C., at least about 220° C., at least about 230° C., at least about 240° C., at least about 250° C., at least about 260° C., at least about 270° C., at least about 280° C., at least about 290° C., at least about 300° C., at least about 310° C., at least about 320° C., at least about 330° C., at least about 340° C., at least about 350° C., or at least about 360° C., at least about 370° C., or at least about 380° C., at least about 390° C., at least about 400° C., at least about 410° C., at least about 420° C., at least about 430° C., at least about 440° C., at least about 450° C., at least about 460° C., at least about 470° C., at least about 480° C., at least about 490° C., at least about 500° C., at least about 510° C., at least about 520° C., at least about 530° C., at least about 540° C., or at least about 550° C., or at least about 560° C., or at least about 570° C., or at least about 580° C., or at least about 590° C., or at least about 600° C., or at least about 610° C., at least about 620° C., at least about 630° C., at least about 640° C., or at least about 650° C., or at least about 660° C., or at least about 670° C., or at least about 680° C., or at least about 690° C., or at least about 700° C., or at least about 710° C., at least about 720° C., at least about 730° C., at least about 740° C., or at least about 750° C., or at least about 760° C., or at least about 770° C., or at least about 780° C., or at least about 790° C., or at least about 800° C., or at least about 810° C., at least about 820° C., at least about 830° C., at least about 840° C., at least about 850° C., at least about 860° C., at least about 780° C., at least about 880° C., at least about 890° C., at least about 900° C., at least about 910° C., at least about 920° C., at least about 930° C., at least about 940° C., at least about 950° C., at least about 960° C., at least about 970° C., at least about 980° C., or at least about 990° C., inclusive, for a duration of at least about 0.5 hours, at least about 1 hours, at least about 1.5, at least about 2 hours, at least about 2.5 hours, at least about 3 hours, at least about 3.5 hours, at least about 4 hours, at least about 4.5, at least about 5 hours, at least about 5.5 hours, or at least about 6 hours, inclusive.

In some embodiments, the heat treatment process can be performed at a temperature of no more than about 1,000° C., no more than about 950° C., no more than about 900° C., no more than about 850° C., no more than about 800° C., no more than about 750° C., no more than about 700° C., no more than about 650° C., no more than about 600° C., no more than about 550° C., no more than about 500° C., no more than about 450° C., no more than about 400° C., no more than about 400° C., no more than about 350° C., or no more than about 300° C., inclusive, for a duration of no more than about 6 hours, no more than about 5.5 hours, no more than about 5 hours, no more than about 4.5 hours, not more than about 4 hours, no, inclusive. Combinations of the above referenced temperatures and time durations are also possible (e.g., at least about 200° C. and no more than about 1,000° C., or at least about 250° C. and no more than about 900° C., for a duration of at least about 0.5 hours and no more than about 6 hours). All such variations are envisioned and should be considered to be within the scope of this disclosure. In some embodiments, the heat treatment operation can be performed at a temperature in a range of about 250° C. to about 900° C., inclusive, for a time of about 1 hour to about 3 hours, inclusive.

In some embodiments, heat treatment can include a two-step process, for example, includes a first heat treatment step followed by a second heat treatment step. In some embodiments, the first heat treatment step can be performed at a temperature of at least about 200° C., at least about 210° C., at least about 220° C., at least about 230° C., at least about 240° C., at least about 250° C., at least about 260° C., at least about 270° C., at least about 280° C., at least about 290° C., at least about 300° C., at least about 310° C., at least about 320° C., at least about 330° C., at least about 340° C., at least about 350° C., at least about 360° C., at least about 370° C., at least about 380° C., at least about 390° C., or at least about 400° C., inclusive, for a duration of at least about 0.5 hours, at least about 1 hours, at least about 1.5, at least about 2 hours, at least about 2.5 hours, at least about 3 hours, inclusive. In some embodiments, the first heat treatment step can be performed at a temperature of no more than about 400° C., no more than about 390° C., no more than about 380° C., no more than about 370° C., no more than about 360° C., no more than about 350° C., no more than about 340° C., no more than about 330° C., no more than about 320° C., no more than about 310° C., no more than about 300° C., no more than about 290° C., no more than about 280° C., no more than about 250° C., or no more than about 260° C., inclusive, for a duration of no more than about 3 hours, no more than about 2.9 hours, no more than about 2.8 hours, no more than about 2.7 hours, no more than about 2.6 hours, no more than about 2.5 hours, no more than about 2.4 hours, no more than about 2.3 hours, no more than about 2.2 hours, or no more than about 2.1 hours, inclusive. Combinations of the above referenced temperatures and time durations are also possible (e.g., at least about 200° C. and no more than about 400° C., or at least about 250° C. and no more than about 300° C., for a duration of at least about 1 hour and no more than about 3 hours). All such variations are envisioned and should be considered to be within the scope of this disclosure. In some embodiments, the first heat treatment step can be performed at a temperature in a range of about 200° C. to about 300° C., inclusive, for a time of about 1 hour to about 3 hours, inclusive.

In some embodiments, the second heat treatment step can be performed at a temperature of at least about 600° C., at least about 620° C., at least about 640° C., at least about 660° C., at least about 680° C., at least about 700° C., at least about 720° C., at least about 740° C., at least about 760° C., at least about 780° C., at least about 800° C., at least about 820° C., at least about 840° C., at least about 860° C., at least about 880° C., at least about 900° C., at least about 920° C., at least about 940° C., at least about 960° C., at least about 980° C., or at least about 1,000° C., inclusive, for a duration of at least about 0.5 hours, at least about 1 hours, at least about 1.5, at least about 2 hours, at least about 2.5 hours, or at least about 3 hours, inclusive. In some embodiments, the second heat treatment step can be performed at a temperature of no more than about 1,000° C., no more than about 990° C., no more than about 980° C., no more than about 970° C., no more than about 960° C., no more than about 950° C., no more than about 940° C., no more than about 930° C., no more than about 920° C., no more than about 910° C., or no more than about 900° C., inclusive for a duration of at least about 0.5 hours, at least about 1 hours, at least about 1.5, at least about 2 hours, at least about 2.5 hours, at least about 3 hours, inclusive. Combinations of the above-referenced temperatures and durations are also possible (e.g., at least about 800° C. and no more than about 1,000° C., or at least about 850° C. and no more than about 950° C., inclusive, for a time duration of at least about 1 hour and no more than about 3 hours). All such variations are envisioned and should be considered to be within the scope of this disclosure. In some embodiments, the second heat treatment step can be performed at a temperature in a range of about 850° C. to about 950° C., inclusive, for a time of about 1 hour to about 3 hours, inclusive. In some embodiments, the second heat treatment step can be done in an inert atmosphere (e.g., argon, xenon, nitrogen, etc.).

Step 17 includes combining the recycled anode material with a second cathode material and a second separator to form a recycled electrochemical cell. In some embodiments, the second cathode material can include recycled cathode material. In some embodiments, the recycled electrochemical cell can have a specific capacity that is greater than a comparable electrochemical cell (i.e., same size cell) including pristine anode powder. In some embodiments, the recycled electrochemical cell can have a specific capacity that is less than the specific capacity of the comparable electrochemical cell by less than about 20%, less than about 19%, less than about 18%, less than about 17%, less than about 16%, less than about 15%, less than about 14%, less than about 13%, less than about 12%, less than about 11%, less than about 10%, less than about 9%, less than about 8%, less than about 7%, less than about 6%, less than about 5%, less than about 4%, less than about 3%, less than about 2%, or less than about 1% of the specific capacity of the comparable electrochemical cell. In some embodiments, the recycled electrochemical cell can have a specific capacity that is less than the specific capacity of the comparable electrochemical cell by less than about 20 mAh/g, less than about 19 mAh/g, less than about 18 mAh/g, less than about 17 mAh/g, less than about 16 mAh/g, less than about 15 mAh/g, less than about 14 mAh/g, less than about 13 mAh/g, less than about 12 mAh/g, less than about 11 mAh/g, less than about 10 mAh/g, less than about 9 mAh/g, less than about 8 mAh/g, less than about 7 mAh/g, less than about 6 mAh/g, less than about 5 mAh/g, less than about 4 mAh/g, less than about 3 mAh/g, less than about 2 mAh/g, or less than about 1 mAh/g.

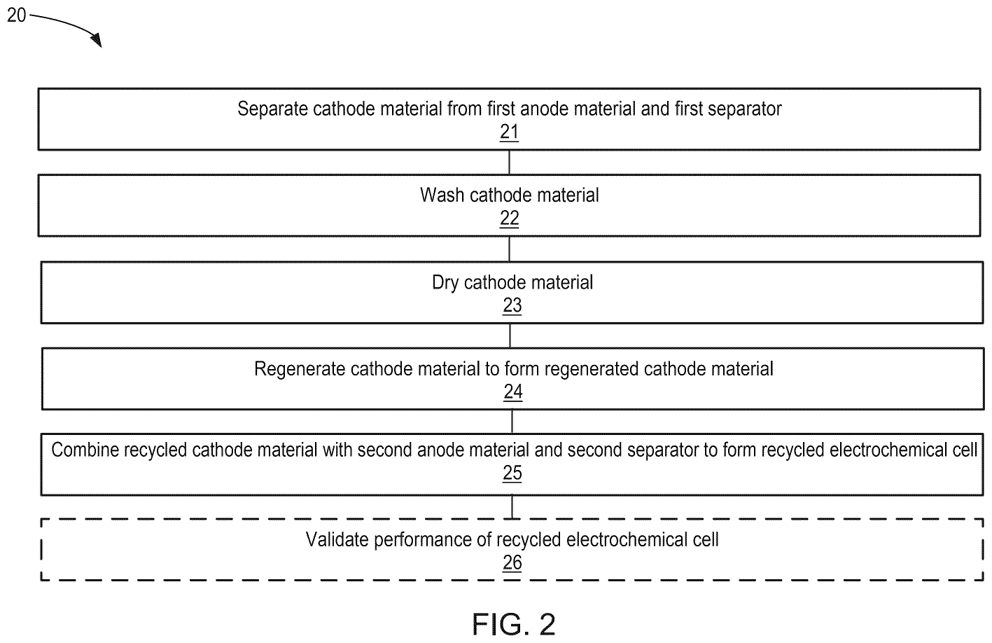

FIG. 2 is a flow diagram of a method 20 of recycling a cathode material from a spent battery, according to an embodiment. The method 20 includes separating a cathode material from an anode material and a separator of a spent (i.e., used) electrochemical cell at step 21 and washing the cathode material at step 22. The method 20 further includes drying the cathode material to form a cathode powder at step 23, regenerating the cathode powder to form a regenerated cathode material at step 24, and combining recycled cathode material with second anode material and second separator to form recycled electrochemical cell at step 25. As shown in FIG. 2, the method 20 optionally includes validating performance of the recycled electrochemical cell at step 26. Several of the steps are described with respect to cathode processing, but can also apply to an anode.

Step 21 includes separating a cathode material from an anode material and a separator of a spent electrochemical cell. In some embodiments, the spent electrochemical cell can be same or substantially similar to the used electrochemical cell of method 10 described above with respect to FIG. 1. In some embodiments, the separation of the cathode material can be manual. In some embodiments, the separation of the cathode material can be fully or partially automated. In some embodiments, the separation of the cathode material can include both manual and automated processes (e.g., use of a robotic arm, conveyor etc.).

In some embodiments, separating the cathode material from the anode material and the separator of the spent electrochemical cell can include mechanical removal, for example by scraping, brushing, shredding, and/or crumpling of a current collector and/or the separator such that the depleted cathode material flakes off, etc. In some embodiments, the cathode material can be removed from the current collector and/or the separator via a blade. In some embodiments, the separation of the depleted cathode material from the electrochemical cell does not involve the use of chemicals (e.g., a process that employs only mechanical implementations). In some embodiments, the separation of the cathode electrode material from the electrochemical cell comprises the “clean” removal of the cathode material from its respective current collector (i.e., such that little or no damage is done to the current collector, and/or substantially none of the current collector material is present in the separated cathode material). As described above, mechanical separation (i.e., from a current collector) of depleted semi-solid cathode material, in particular, may require only a low applied force to remove, for example due to its semi-solid physical state and/or the absence of a binder. After the depleted cathode material is separated from the current collector, it may optionally be pulverized or ground to produce a free-flowing powder for subsequent process steps. Optionally, this pulverization or grinding step may be applied at another time in the process or it may be applied several times throughout the method 20.

In some embodiments, separating the cathode material from the anode material and the separator of the spent electrochemical cell can include at least one of: scraping, ultrasonication, or vacuuming. In some embodiments, the cathode material can be removed via scraping. In some embodiments, the cathode material can be removed via vacuuming (e.g., vacuum filtration). In some embodiments, the cathode material can be removed via ultrasonication. In some embodiment, the cathode (including cathode material that can include active and conductive material and cathode current collector) may be ultrasonicated in a solvent and then subjected to vacuum filtration to separate the cathode material from the anode material.

In some embodiments, the spent electrochemical cell can be soaked in a liquid for a soaking period prior to separation of the cathode material from the anode material at step 21 in order to make the separation of the cathode material easier. In some embodiments, the liquid can include an organic solvent. In some embodiments, the organic solvent includes at least one of a linear carbonate, a cyclic carbonate, a cyclic ether, an alcohol, dimethyl carbonate (DMC), dimethyl ether (DME), tetrahydrofuran (THF), methyl acetate (MA), ethyl acetate (EA), ethyl methyl carbonate (EMC), diethyl carbonate (DEC), acetonitrile (ACN), or isopropyl alcohol (IPA), and/or N-methylpyrrolidone (NMP). In some embodiments, the cathode material can be soaked in isopropyl alcohol. The absence of a binder in the cathode material can allow for easier separation of the cathode material from the separator (i.e., without any additional processing steps). In some embodiments, the soaking period can be at least about 5 minutes, at least about 10 minutes, at least about 30 minutes, at least about 1 hour, at least about 2 hours, at least about 3 hours, at least about 4 hours, at least about 6 hours, at least about 8 hours, at least about 10 hours, or at least about 12 hours. In some embodiments, the soaking period can be no more than about 48 hours, no more than about 24 hours, no more than about 18 hours, no more than about 12 hours, no more than about 10 hours, no more than about 8 hours, no more than about 6 hours, no more than about 4 hours, or no more than about 2 hours. Combinations of the above-referenced values are also possible (e.g., at least about 5 minutes and no more than 48 hours or at least about 1 hour and no more than about 4 hours), inclusive of all values and ranges therebetween.

In some embodiments, the cathode material can include a semi-solid material. In some embodiments, the cathode material is binderless. In some embodiments, the cathode material can include at least one of a layered oxide, a spinel oxide, or a polyanion oxide. In some embodiments, the cathode material can be subject to at least one of a doping, or a surface treatment.

In some embodiments, the cathode material can include the general family of ordered rocksalt compounds LiMO₂ including those having the α-NaFeO₂ (so-called “layered compounds”) or orthorhombic-LiMnO₂ structure type or their derivatives of different crystal symmetry, atomic ordering, or partial substitution for the metals or oxygen. Here, M comprises at least one first-row transition metal but may include non-transition metals including, but not limited to, Al, Ca, Mg, or Zr. Examples of such compounds include LiFePO₄ (LFP), LiCoO₂, LiCoO₂ doped with Mg, LiNiO₂, Li(Ni, Co, Al)O₂ (known as “NCA”) and Li(Ni, Mn, Co)O₂ (known as “NMC”). In some embodiments, the cathode material can include a spinel structure, such as LiMn₂O₄ and its derivatives, so-called “layered-spinel nanocomposites” in which the structure includes nanoscopic regions having ordered rocksalt and spinel ordering, olivines LiMPO₄ and their derivatives, in which M comprises one or more of Mn, Fe, Co, or Ni, partially fluorinated compounds such as LiVPO₄F, other “polyanion” compounds as described below, and vanadium oxides VₓO_{y} including V₂O₅ and V₆O₁₁. In some embodiments, the cathode material can include a transition metal polyanion compound. In some embodiments, the cathode material can include an alkali metal transition metal oxide or phosphate, and for example, the compound has a composition Aₓ(M′₁₋ₐM″ₐ)_{y}(XD₄)_{z}, Aₓ(M′₁₋ₐM″ₐ)_{y}(DXD₄)_{z}, or Aₓ(M′₁₋ₐM″ₐ)_{y}(X₂D₇)_{z}, and have values such that x, plus y(1−a) times a formal valence or valences of M′, plus y(a) times a formal valence or valence of M″, is equal to z times a formal valence of the XD₄, X₂D₇, or DXD₄ group; or a compound comprising a composition (A₁₋ₐM″ₐ)ₓM′_{y}(XD₄)_{z}, (A₁₋ₐM″ₐ)ₓ(M′_{y}(DXD₄)_{z}(A₁₋ₐM″ₐ)ₐM′_{y}(X₂D₇)_{z} and have values such that (1−a)x plus the quantity ax times the formal valence or valences of M″ plus y times the formal valence or valences of M′ is equal to z times the formal valence of the XD₄, X₂D₇ or DXD₄ group. In the compound, A is at least one of an alkali metal and hydrogen, M′ is a first-row transition metal, X is at least one of phosphorus, sulfur, arsenic, molybdenum, and tungsten, M″ any of a Group HA, IIIA, IVA, VA, VIA, VIIA, VIIIA, IB, IIB, IIIB, IVB, VB, and VIB metal, D is at least one of oxygen, nitrogen, carbon, or a halogen. The positive electroactive material can be an olivine structure compound LiMPO₄, where M is one or more of V, Cr, Mn, Fe, Co, and Ni, in which the compound is optionally doped at the Li, M or O-sites. Deficiencies at the Li-site are compensated by the addition of a metal or metalloid, and deficiencies at the O-site are compensated by the addition of a halogen. In some embodiments, the positive active material comprises a thermally stable, transition-metal-doped lithium transition metal phosphate having the olivine structure and having the formula (Li₁₋ₓZₓ)MPO₄, where M is one or more of V, Cr, Mn, Fe, Co, and Ni, and Z is a non-alkali metal dopant such as one or more of Ti, Zr, Nb, Al, or Mg, and x ranges from 0.005 to 0.05.

Step 22 includes washing the cathode material after separating the spent (i.e., used) cathode material from the spent anode material and the separator at step 21. The washing can aid removal of one or more residues, such as electrolyte salt(s), electrolyte solvent, or a reaction product formed during the operation of the battery. In some embodiments, the washing at step 22 can aid in removal of electrolyte salt and/or solvent from the cathode material. In some embodiments, the washing can be via a single washing liquid. In some embodiments, the washing can be via multiple washing liquids. In some embodiments, the washing can be via an organic liquid. In some embodiments, the washing can be via an inorganic liquid. In some embodiments, the washing can be via a polar liquid. In some embodiments, the washing can be via a non-polar liquid.

In some embodiments, the washing can be via at least one of an organic solvent or water. In some embodiments, the washing can be via a single washing liquid including at least one of an organic solvent or water. In some embodiments, the washing can be via multiple washing liquids, each washing liquid independently including at least one of an organic solvent or water. In some embodiments, water is deionized. In some embodiments, the organic solvent includes at least one of a linear carbonate, a cyclic carbonate, a cyclic ether, an alcohol, dimethyl carbonate (DMC), dimethyl ether (DME), tetrahydrofuran (THF), methyl acetate (MA), ethyl acetate (EA), ethyl methyl carbonate (EMC), diethyl carbonate (DEC, acetonitrile (ACN), isopropyl alcohol (IPA), and/or N-methylpyrrolidone (NMP).

Step 23 includes drying the cathode material to form a cathode powder. In some embodiments, a vacuum can be applied during at least a part of the drying. In some embodiments, the vacuuming can be to a pressure of less than about 1 bar (absolute), less than about 0.95 bar, less than about 0.9 bar, less than about 0.85 bar, less than about 0.8 bar, less than about 0.75 bar, less than about 0.7 bar, less than about 0.65 bar, less than about 0.6 bar, less than about 0.55 bar, less than about 0.5 bar, less than about 0.45 bar, less than about 0.4 bar, less than about 0.35 bar, less than about 0.3 bar, less than about 0.25 bar, less than about 0.2 bar, less than about 0.15 bar, or less than about 0.1 bar, inclusive of all values and ranges therebetween

In some embodiments, the drying can be at a temperature of between about 220° C. and about 280° C. for a period between about 10 hours and about 15 hours. In some embodiments, the drying can be at about 250° C. for about 12 hours.

In some embodiments, the drying can be via freeze-drying. In some embodiments, the drying can be via heat drying, subcritical carbon dioxide extraction, supercritical carbon dioxide extraction, and/or solvent mass extraction (e.g., with non-aqueous or aqueous solvents).

In some embodiments, the drying can be via heating the liquid phase to vaporize the liquid phase and leave the active material. In some embodiments, the drying can be via an oven. In some embodiments, the drying step can be at a temperature of at least about 80° C., at least about 90° C., at least about 100° C., at least about 110° C., at least about 120° C., at least about 130° C., at least about 140° C., at least about 150° C., at least about 160° C., at least about 170° C., at least about 180° C., at least about 190° C., at least about 200° C., at least about 210° C., or at least about 220° C. In some embodiments, the drying step can be at a temperature of no more than about 350° C., no more than about 340° C., no more than about 330° C., no more than about 320° C., no more than about 310° C., no more than about 300° C., no more than about 290° C., or no more than about 280° C. Combinations of the above-referenced temperatures are also possible (e.g., at least about 80° C. and no more than about 350° C. or at least about 220° C. and no more than about 280° C.), inclusive of all values and ranges therebetween. In some embodiments, the drying step can be at a temperature of about 80° C., about 100° C., about 120° C., about 140° C., about 150° C., about 170° C., about 190° C., about 200° C., about 220° C., about 240° C., or about 250° C.

In some embodiments, the drying step can have a duration of at least about 1 minute, at least about 5 minutes, at least about 10 minutes, at least about 20 minutes, at least about 30 minutes, at least about 40 minutes, at least about 50 minutes, at least about 1 hour, at least about 2 hours, at least about 3 hours, at least about 4 hours, at least about 5 hours, at least about 6 hours, at least about 7 hours, at least about 8 hours, at least about 9 hours, at least about 10 hours, at least about 11 hours, at least about 12 hours, at least about 13 hours, at least about 14 hours, at least about 15 hours, at least about 16 hours, at least about 17 hours, at least about 18 hours, or at least about 19 hours. In some embodiments, the first drying step can have a duration of no more than about 20 hours, no more than about 19 hours, no more than about 18 hours, no more than about 17 hours, no more than about 16 hours, no more than about 15 hours, no more than about 14 hours, no more than about 13 hours, no more than about 12 hours, no more than about 11 hours, no more than about 10 hours, no more than about 9 hours, no more than about 8 hours, no more than about 7 hours, no more than about 6 hours, no more than about 5 hours, no more than about 4 hours, no more than about 3 hours, no more than about 2 hours, no more than about 1 hour, no more than about 50 minutes, no more than about 40 minutes, no more than about 30 minutes, no more than about 20 minutes, or no more than about 10 minutes. Combinations of the above-referenced durations are also possible (e.g., at least about 1 minute and no more than about 20 hours or at least about 30 minutes and no more than about 4 hours), inclusive of all values and ranges therebetween. In some embodiments, the first drying step can have a duration of about 1 minute, about 5 minutes, about 10 minutes, about 20 minutes, about 30 minutes, about 40 minutes, about 50 minutes, about 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, or about 20 hours.

Step 24 includes regenerating the cathode powder to form a regenerated cathode material. At step 24, the regeneration of the cathode power includes mixing and/or adding a lithium source to the cathode powder to produce a regenerated cathode material. In some embodiments, regenerating the cathode powder can include at least one of solid-state relithiation (e.g., high temperature, e.g., at least about 500° C., solid-state relithiation), wet chemistry relithiation (e.g., low temperature, e.g., no more than about 200° C., wet chemistry lithiation), or chemical leaching (e.g., acid leaching) and re-synthesis. In some embodiments, chemical leaching may include leaching the cathode powder in an aqueous or acidic solution (e.g., a citric acid or acetic acid solution) including a lithium source (e.g., a lithium salt).

The addition of a lithium source to the cathode powder can compensate for “missing” lithium lost during cycling of the electrochemical cell. In some embodiments, the lithium source can include at least one of lithium carbonate, lithium hydroxide, lithium nitrate, lithium sulfate, or any lithium salt. In some embodiments, the lithium source may include recycled lithium or lithium compounds. For example, in some embodiments, the recycled lithium may be obtained from a used anode. In some embodiments, the lithium source may include recycled lithium obtained from a used anode by using a lithium removal agent. In such embodiments, the lithium source can be mixed and/or added to replenish an amount of lithium loss on the cathode powder due to cycling of the electrochemical cell. In some embodiments, the amount of lithium source to be mixed and/or added to the cathode powder can be a mass or weight of lithium source which includes sufficient lithium to replenish about 1% of lost lithium, about 2% of lost lithium, about 3% of lost lithium, about 5% of lost lithium, about 8% of lost lithium, about 10% of lost lithium, about 12% of lost lithium, about 15% of lost lithium, about 20% of lost lithium, about 25% of lost lithium, about 30% of lost lithium, about 35% of lost lithium, about 40% of lost lithium, about 45% of lost lithium, about 50% of lost lithium, about 55% of lost lithium, about 60% of lost lithium, about 65% of lost lithium, or about 70% of lost lithium of the cathode material, inclusive of all ranges therebetween.

In some embodiments, mixing and/or adding a lithium source to the cathode powder to form a regenerated cathode material can be substantially solvent free (i.e., solid state). In such embodiments, a heat treatment process can be applied to the cathode powder after the cathode powder has been mixed with a lithium source. In some embodiments, a gas stream may be flowed over the electrode active material during heating to provide a controlled atmosphere. In some embodiments, at least a part of the heat treatment process can be at a temperature of at least about 80° C., at least about 90° C., at least about 100° C., at least about 110° C., at least about 120° C., at least about 130° C., at least about 140° C., at least about 150° C., at least about 160° C., at least about 170° C., at least about 180° C., at least about 190° C., at least about 200° C., at least about 210° C., at least about 220° C., at least about 250° C., at least about 300° C., at least about 350° C., at least about 400° C., at least about 450° C., at least about 500° C. In some embodiments, at least a part of the heat treatment process can be at a temperature of no more than about 950° C., no more than about 900° C., no more than about 850° C., no more than about 800° C., no more than about 750° C., no more than about 700° C., no more than about 650° C., no more than about 600° C., no more than about 550° C., no more than about 500° C., or no more than about 450° C. Combinations of the above-referenced temperatures are also possible (e.g., at least about 80° C. and no more than about 750° C. or at least about 220° C. and no more than about 900° C.), inclusive of all values and ranges therebetween.

In some embodiments, mixing and/or adding a lithium source to the cathode powder to form a regenerated cathode material can be performed within a liquid (i.e., wet chemistry relithiation). In some embodiments, the liquid may include at least one of an organic solvent, or water. In some embodiments, mixing and/or adding a lithium source to the cathode powder to form a regenerated cathode material can be performed in the presence of a reducing agent that includes organic acids, alcohols (ethanol, methanol, isopropanol, ethyl alcohol, etc.), glycols, hydrogen peroxide and others. In some embodiments, the organic acids can include but are not limited to citric acid, acetic acid, formic acid, glycolic acid, carbonic acid, oxalic acid, malonic acid, maleic acid, malic acid, ascorbic acid, lactic acid, tartaric acid, butyric acid, folic acid, uric acid, and their combinations. In some embodiments, alcohols can include ethanol, methanol, isopropyl alcohol. In some embodiments, glycols can include ethylene glycol, propylene glycol. In some embodiments, other reducing agents can include boron hydride and hydrazine hydrate.

Step 25 includes combining the recycled cathode material with the second anode material and the second separator to form a recycled electrochemical cell. In some embodiments, the second anode material may be recycled. In some embodiments, the second anode material may be pristine. In some embodiments, combining the recycled cathode material with the second anode material and the second separator can be performed via automated systems and/or manually. In some embodiments, combining the recycled cathode material with the second anode material and the second separator may be performed in multiple steps.

Step 26 is optional and includes validating performance of the recycled electrochemical cell. At step 26, the validation of performance of the recycled electrochemical cell may include the use of at least one of voltammetry, amperometry, or impedance spectroscopy. In some embodiments, the validation of performance of the recycled electrochemical cell may include generating cell voltage vs. capacity plots to evaluate the performance and capacity retention of the recycled electrochemical cells.

The method 20 for cathode recycling process presents several advantages. Firstly, the binder-free cathode simplifies the recycling process, eliminating the need for additional steps to remove the binder. This not only reduces the overall cost but also streamlines the process. Secondly, the absence of hydrofluoric acid (HF) generation due to polyvinylidene fluoride (PVDF) binder decomposition significantly reduces environmental impact. This makes the method 20 an environmentally friendly and cost-effective solution for binderless cathode recycling process. The method 20 can also be adapted for recycling of conventional used cathodes with addition of one or more steps including at least one of washing, drying or filtering.

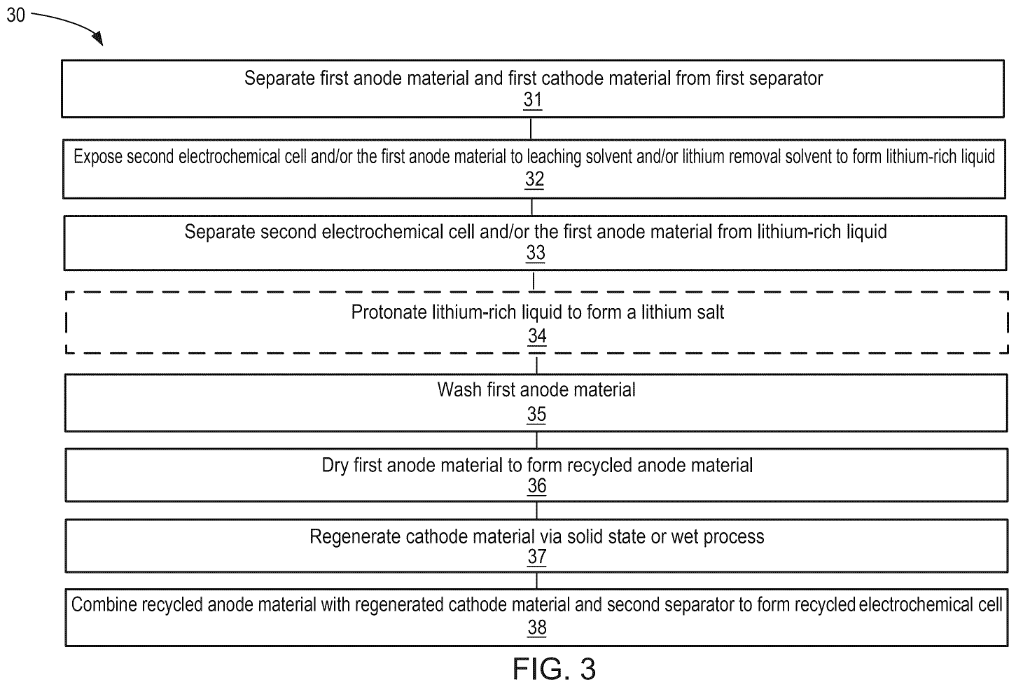

FIG. 3 is a flow diagram of a method 30 of recycling a spent battery, according to an embodiment. The method 30 includes separating a first anode material and a first cathode material from a first separator, at step 31. The first anode material, the first cathode material, and the first separator are included in a first electrochemical cell. The method 30 further includes exposing a second electrochemical cell and/or the first anode material to at least one of a leaching solvent or a lithium removal solvent to form a lithium-rich liquid, at step 32. The method 30 further includes separating the second electrochemical cell and/or the first anode material from lithium-rich liquid, at step 33. As shown in FIG. 3, the method 30 can optionally include drying lithium-rich liquid to form lithium metal, at step 34. The method 30 further includes washing the first anode material, at step 35; drying the first anode material to form a recycled anode material, at step 36; and mixing lithium metal from the lithium-rich liquid with the first cathode material to form a regenerated cathode material, at step 37. The method 30 can optionally include (not shown in FIG. 3) post-processing the regenerated cathode material. The method 30 further includes combining the recycled anode material with the regenerated cathode material and a second separator to form a recycled electrochemical cell, at step 38.

Step 31 can be similar to and/or substantially the same as the step 11 and step 21 of the method 10 and method 20 described above with reference to FIG. 1 and FIG. 2, respectively.

Step 32 includes exposing a second electrochemical cell and/or the first anode material to at least one of a leaching solvent or a lithium removal solvent to form a lithium-rich liquid. In some embodiments, the lithium removal solvent includes a lithium removal agent. In some embodiments, the lithium removal agents can include biphenyl, naphthalene, 2-methyl biphenyl, 3,3′-dimethyl biphenyl, 4,4′-dimethyl biphenyl, 3,3′,4,4′-tetramethyl biphenyl and/or other molecules with a strong electron affinity that conjugates with electron donating alkaline metals (e.g., lithium, sodium) to form negatively charged radicals. The lithium removal agents can be dispersed in organic solvents including, but not limited to dimethyl carbonate (DMC), dimethyl ether (DME), tetrahydrofuran (THF), or any combination thereof.

In some embodiments, the leaching solvent can include an acid. In some embodiments, the acid can include a weak acid such as citric acid, citric acid, acetic acid, formic acid, phosphoric acid, carbonic acid, and nitrous acid. In some embodiments, the acid can include a strong acid such as hydrochloric acid (HCl) and sulfuric acid (H₂SO₄). In some embodiments, the leaching solvent agent can include an aqueous solution of any of the aforementioned weak or strong acids.

The lithium removal agent used at step 32 can enable recovery of lithium metal from used electrochemical cells and/or used anodes. For example, the lithium removal agent can remove the leftover lithium from used anodes such that a lithium rich liquid can be formed. In some embodiments, a lithium source as described above with respect to FIG. 2 can be added to the lithium rich liquid to increase the lithium content (i.e., concentration, for example, molar concentration, wt %, vol %, etc.).

Step 33 includes separating the second electrochemical cell and/or the first anode material from the lithium-rich liquid including the leaching solvent or the lithium removal solvent. In some embodiments, the separation of the second electrochemical cell and/or the first anode material from the lithium-rich liquid can be via a filtration. In some embodiments, the separation of the second electrochemical cell and/or the first anode material from the lithium-rich liquid can be via centrifugation. In some embodiments, separation of the second electrochemical cell and/or first anode material from the lithium rich liquid can be via ultrasonication and/or vacuum filtration.

Once step 33 is completed, in some embodiments, the separated lithium-rich liquid can be used for regeneration of a cathode. Once step 33 is completed, in some embodiments, the separated first anode can be used to form a recycled anode material after exposing one or more post-treatment steps including washing and drying.

Step 34, which is optional, involves the protonation of the lithium-rich liquid to yield a lithium salt (e.g., lithium hydroxide (LiOH)). In some embodiments, the protonation process can be performed by mixing water with the lithium naphthalene crystals obtained by evaporating the solvent of the lithium-rich liquid. The protonation reaction can yield compounds, for example, hydrated lithium hydroxide including, naphthalene and 1,2-dihydronaphthalene. The lithium hydroxide can then be separated from the protonated compounds via filtration (e.g., vacuum filtration) with ethereal solvents.

Steps 35, 36, and 38 can be similar to and/or substantially the same as steps 13, 15, and 17 of the method 10 described above with reference to FIG. 1, and therefore not described in further detail herein.

At step 37, the cathode is regenerated by a solid state process or a wet process. In some embodiments, for a solid state process, lithium salt (e.g., LiOH) obtained from step 34 can be mixed with dry cathode to perform solid state regeneration reaction. For the wet process or wet chemistry reaction, the lithium-rich solution (e.g., Li-Naphthalene also referred to herein as “Li-Nap”) can directly mix and relithiate dry cathode to regenerate. After reaction, the Li-Nap solution will turn into Nap solution, which can be reused as lithium removal solvent. In some embodiments, the Li-salt (e.g., LiOH) can be used as the additional lithium source described with respect to step 32. In some embodiments, the Li-salt (e.g., LiOH) can be used as a precursor to make cathode from scratch. In some embodiments, step 38 can be similar to and/or substantially the same as the step 24 of the method 20 described above with reference to FIG. 2.

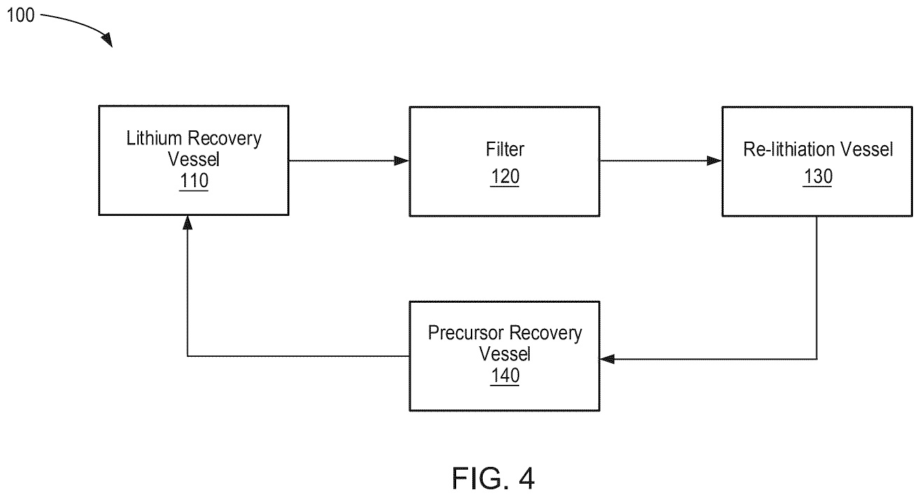

FIG. 4 is a block diagram of a system 100 for recovering and recycling components of an electrochemical cell, according to an embodiment. The system 100 includes a lithium recovery vessel 110, an optional filter 120, a re-lithiation vessel 130, and a precursor recovery vessel 140.

The lithium recovery vessel 110, the re-lithiation vessel 130, and the precursor recovery vessel 140 can be in a form of any shape (e.g., a cylindrical, cube, etc.). The lithium recovery vessel 110, the re-lithiation vessel 130, and the precursor recovery vessel 140 can include tanks, vessels, and/or any of the process units. In some embodiments, at least two components of the system 100 can be connected through pipes, conduits, or any connection means that enables material flow from one vessel (e.g., lithium recovery vessel 110) to another vessel (re-lithiation vessel).

The lithium recovery vessel 110 has an internal volume in which lithium recovery process can take place. In some embodiments, the lithium recovery process can include recovering lithium from a used anode. In some embodiments, the lithium recovery process can include recovering lithium from a used electrode. In some embodiments, the lithium recovery process can include use of a lithium removal agent. In some embodiments, the lithium recovery process can include use of a lithium removal agent (e.g., C₁₀H₈, i.e., naphthalene which can be in the form of mothballs) dispersed or dissolved within a solvent (e.g., DME). In some embodiments, step 32 of the method 30 described above with respect to FIG. 3 can be performed at the lithium recovery vessel 110.

After recovering lithium from a used electrochemical device (e.g., used anode), the filter 120 can optionally be used to separate recovered lithium from the used electrochemical device. In some embodiments, the filter 120 can be coupled with a Buchner funnel.

The re-lithiation vessel 130 has an internal volume in which re-lithiation of cathode materials (i.e., regeneration of cathode) can take place. In some embodiments, the re-lithiation vessel 130 can include lithium recovered at the lithium recovery vessel. In some embodiments, the re-lithiation vessel 130 can include lithium removal agents from the lithium recovery vessel 110 including lithium recovered from used electrochemical cells. In some embodiments, step 37 of the method 30 described above with respect to FIG. 3 can be performed at the re-lithiation vessel 130.

In some embodiments, once lithium recovered by the lithium removal agents is partially or completely consumed at the re-lithiation vessel 130, the regenerated lithium removal agents can be returned to precursor recovery vessel 140 to be reused for another lithium recovery process at the lithium recovery vessel 110.

The system 100 is designed to maximize material recycling (e.g., lithium, lithium removal agents etc.) during the process, thereby reducing the overall cost of the recycling process described above with respect to FIGS. 1-3.

### EXAMPLES

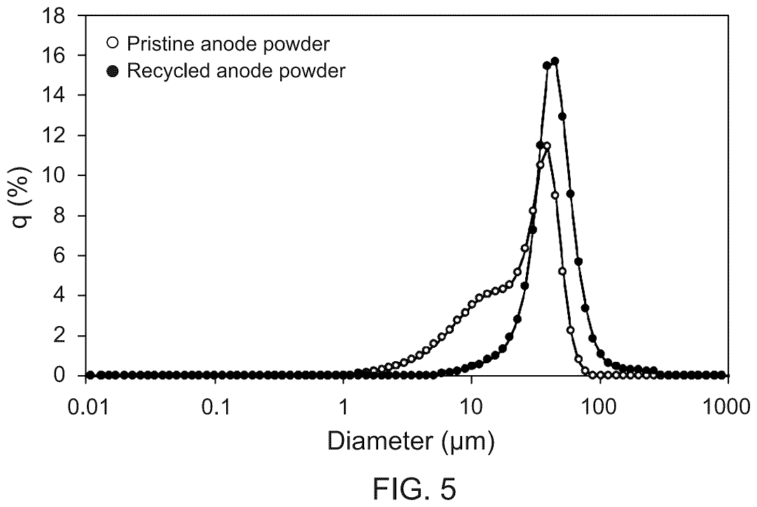

FIG. 5 is a graphical comparison of the particle size distributions of pristine anode powder as compared to recycled anode powder. Particle size analysis of anode powder, both pristine and recycled, was conducted post-washing and drying. The results revealed a similar average particle size for both types, predominantly around 50 μm. However, the curve for the pristine anode powder also peaks around a diameter of about 10 μm, suggesting the presence of a minor population of smaller particles in the pristine anode powder. Notably, the curve representing the recycled anode powder lacks the “shoulder” at around 10 μm. This difference in the distribution of smaller particles is likely due to the filtering process used during recycling. Small particles may have passed through the filter paper, resulting in their absence in the recycled anode powder. This issue could potentially be mitigated by using a filter paper with smaller pore size or by employing centrifugation during the powder collection process. These modifications can aim to enhance the consistency of particle size distribution in the recycled anode powder.

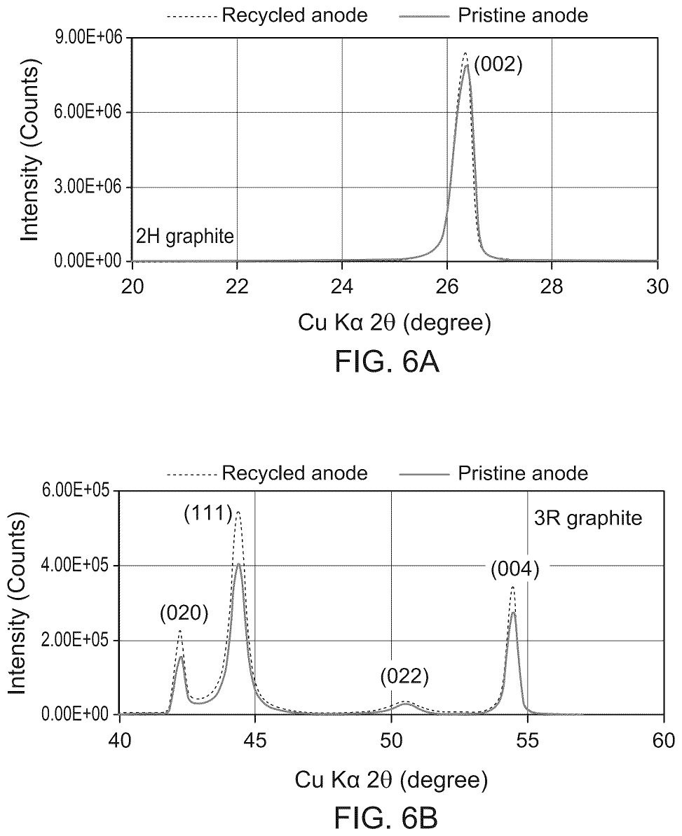

FIGS. 6A-6B show structure characterization via x-ray diffraction (XRD) of pristine anode powder, as compared to recycled anode powder. The XRD patterns of recycled and pristine anode powders, depicted in FIGS. 6A-6B, reveal nearly identical structures, suggesting that the anode's structure remains intact after long-term cycling and the recycling process. Both the recycled and pristine anodes exhibit characteristic peaks associated with the 2H (FIG. 6A) and 3R (FIG. 6B) graphite structures, which are consistent with the literature. This further confirms that the recycling process does not significantly degrade the anode's crystal structure. A detailed analysis of the (002) peaks, representing the interlayer spacing in the graphite structure, reveals a minor difference between the two samples. The interlayer spacing was calculated using Bragg's Law, which is a fundamental principle in X-ray crystallography that relates the angles of incident and scattered X-rays to the spacings between crystal planes in a sample. Accordingly, the recycled graphite displays a slightly larger (002) interlayer spacing (3.382 Å) compared to the pristine graphite (3.379 Å). This discrepancy may be due to the presence of residual lithium ions trapped within the graphite layers, which were not entirely removed during the washing process.

The trapped lithium ions could potentially be extracted by washing with a mild acid, such as boric acid. This can help maintain the structural integrity and performance of the recycled anode powder, thereby enhancing its viability for reuse in battery manufacturing.

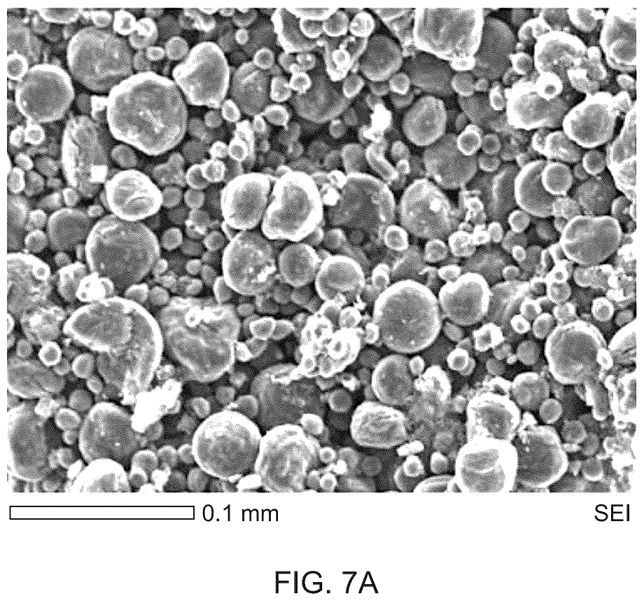

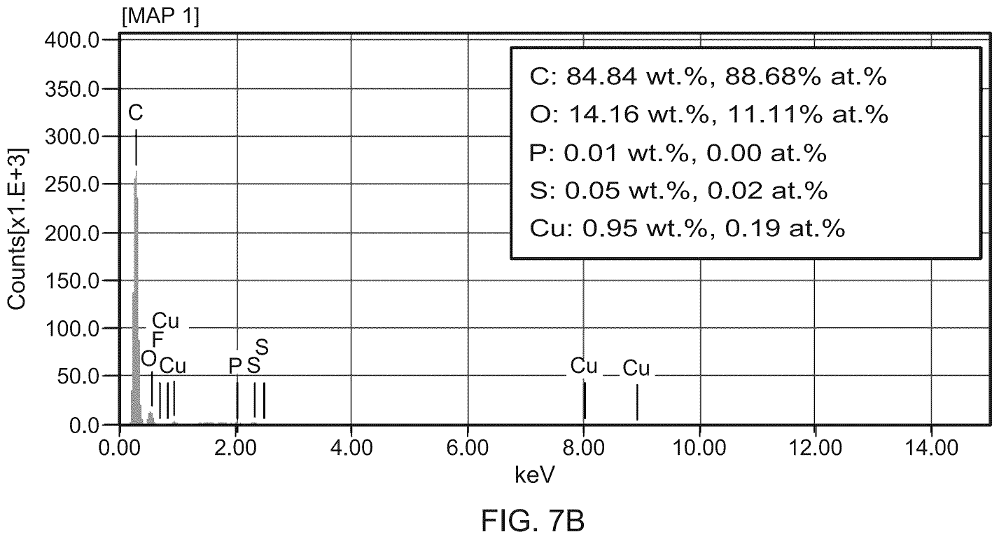

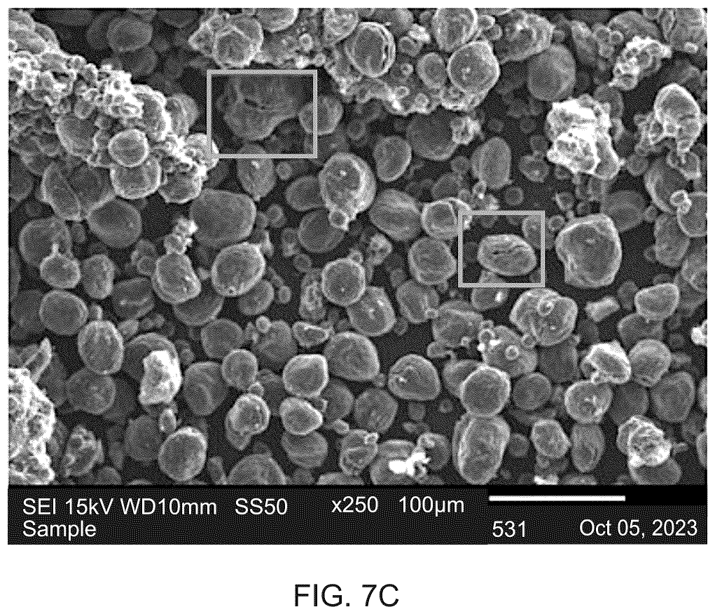

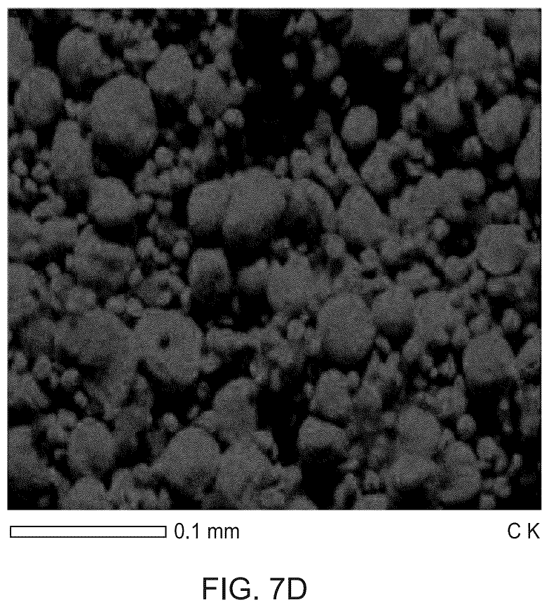

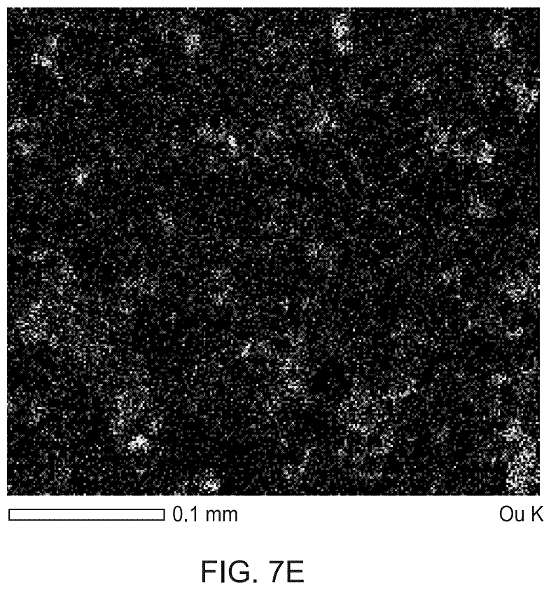

FIGS. 7A-7E show morphology and compositions of recycled anode materials via scanning electron microscopy (SEM) and energy dispersive x-ray spectroscopy (EDS). FIGS. 7A-7E show the morphology of recycled anode powder at low (FIG. 7A) and high (FIG. 7C) magnification, the EDS spectrum (FIG. 7B), and elemental mapping (FIG. 7D and FIG. 7E) of the recycled anode powder. The images reveal that the particles are predominantly spherical in shape, with a mixture of large and small particles. At lower magnification (FIG. 7A), no visible damage is observed on the recycled graphite particles. However, at higher magnification (FIG. 7C), a few graphite particles exhibit cracks on their surface, possibly formed during long-term cycling and not repairable by the washing and drying process. The EDS spectrum (FIG. 7B) does not show elements from SEI such as P and F, indicating the effectiveness of the washing process in removing the anode SEI. The residue SEI decomposition product content is either small or below the detection limit of EDS. The EDS mapping (FIG. 7D and FIG. 7E) reveals the presence of copper (Cu) on the graphite surface. This could be due to the dissolution of Cu from the Cu foil during long-term cycling and the final discharge to a low voltage before the cell was torn down to collect the anode powder. This observation suggests that the recycled anode particles are predominantly spherical and that the washing process effectively removes the SEI, but some traces of Cu remain.

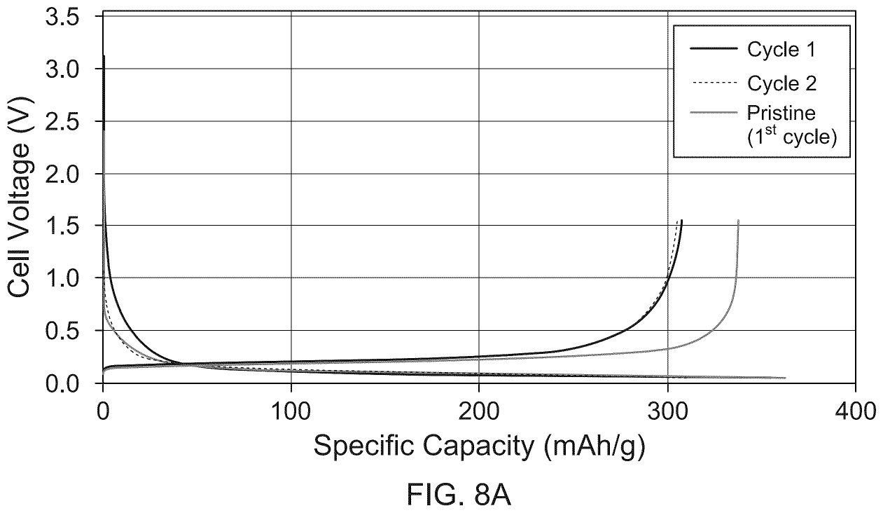

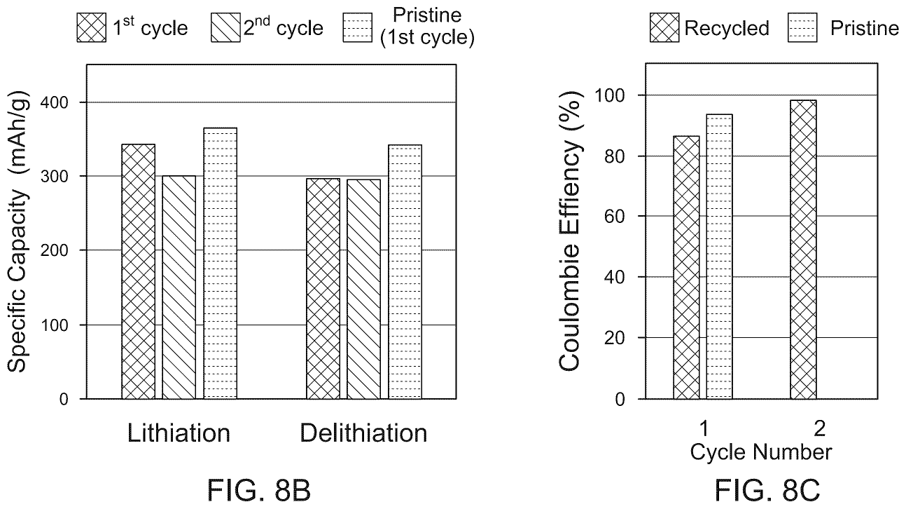

FIGS. 8A-8C show graphical comparisons of capacity and coulombic efficiency of electrochemical cells with recycled and pristine anode materials. FIGS. 8A, 8B, and 8C depict the charge and discharge voltage profile, capacity, and coulombic efficiency of recycled anode during the first two cycles, respectively. After washing and drying, the anode powders were tested in coin cells. The recycled anode demonstrated a specific capacity of 351 mAh/g during the first lithiation and 300 mAh/g during the first de-lithiation (FIG. 8A). The reversible capacity of the recycled anode reached 88% of the capacity of the pristine anode after the washing and drying process (FIG. 8B). The first cycle coulombic efficiency was 87%, slightly lower than that of the pristine anode (93%). This lower coulombic efficiency of the recycled anode could be partly attributed to the increased surface area of the graphite due to particle cracks, leading to more side reactions with the electrolyte. However, the coulombic efficiency of the recycled anode increased to 98.4% in the second cycle (FIG. 8C), indicating the stabilization of the solid electrolyte interphase (SEI) layer. Further improvements of the recycled anode are currently under investigation and may require additional steps, including the removal of residue lithium and modification of the anode surface.

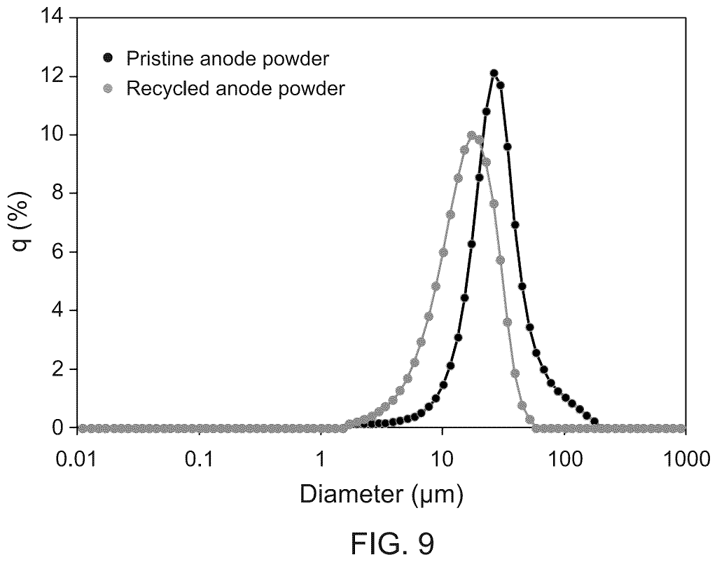

FIG. 9 is a graphical comparison of the particle size distributions of pristine anode powder as compared to recycled anode powder. FIG. 9 presents the particle size distribution of recycled versus pristine anode powder in a different cell, specifically a spent semi-solid cell (30 Ah cell after cycling at C/4 current for 100 cycles). This cell, compared to the cell used in FIG. 5, has undergone fewer cycles and exhibits less capacity degradation. The particle size of the anode powder, measured by a particle size analyzer after the washing and drying processes, shows a monomodal distribution. The average particle size of the anode powder before recycling is slightly larger than that after recycling, mirroring observations made in FIG. 5. This indicates a loss of fine particles (i.e., smaller particles) during the washing and filtering process, resulting in an increased material size in the recycled anode compared to the pristine anode. The washing process can be optimized to minimize the loss of fine particles and maintain the particle size distribution closer to that of the pristine anode.

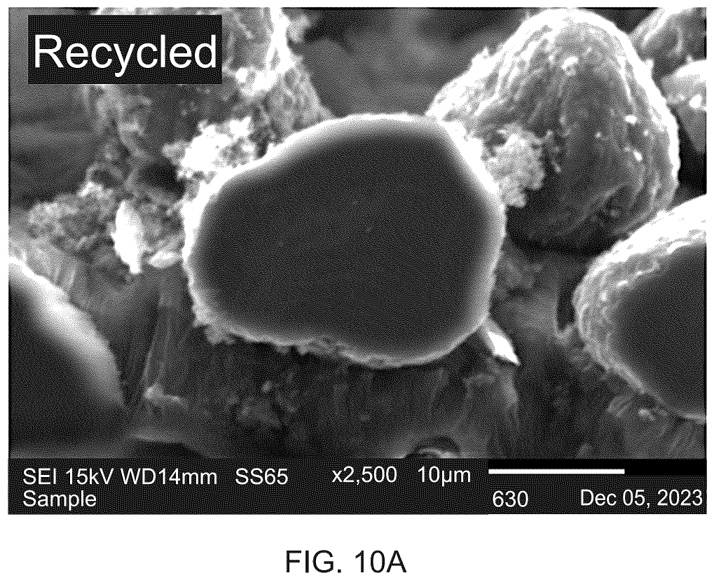

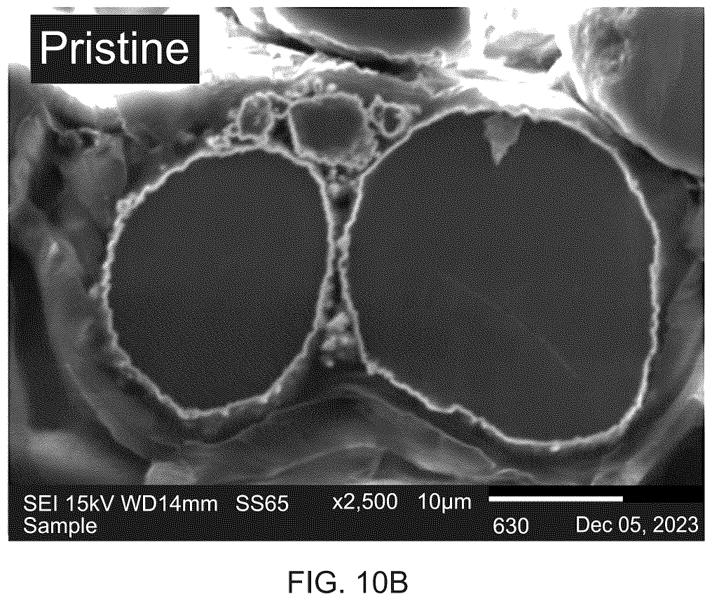

FIGS. 10A-10B show recycled anode powder, as compared to pristine anode powder, as viewed via SEM. FIG. 10A and FIG. 10B present the scanning electron microscopy (SEM) cross-section images of recycled and pristine anode particles, respectively. Both types of anode powders exhibit spherical particles. Notably, unlike the samples shown in FIGS. 7A-7E, no particle damage is observed in the recycled anode particles. This could be attributed to the fewer cycles experienced by the new end-of-life (EOL) cells used in this instance. Upon comparison, no noticeable differences are found between the recycled and pristine anode particles in terms of their cross-sectional SEM images. This suggests that the recycling process preserves the integrity of the anode particles, maintaining their spherical shape and overall structure.

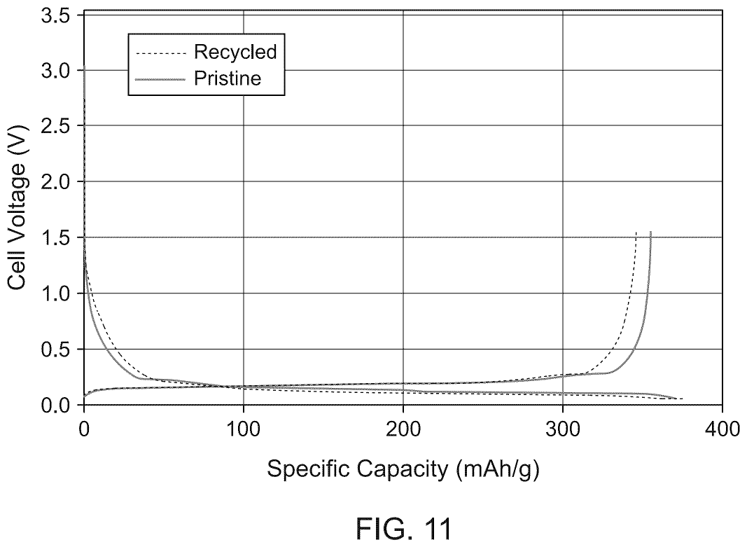

FIG. 11 is a graphical comparison of specific capacities of electrochemical cells with pristine anode materials and recycled anode materials. FIG. 11 illustrates the charge and discharge voltage profile of both recycled and pristine anode during the first cycle. The recycled anode demonstrates a similar first lithiation capacity of 377 mAh/g, but a slightly lower de-lithiation capacity of 347 mAh/g when compared to the pristine anode. This results in the recycled anode achieving about 97% of the reversible capacity of the pristine anode, which is a notable improvement from the previous sample shown in FIG. 8A. The first cycle coulombic efficiency of the recycled anode is 92%, which is slightly lower than the 95% efficiency of the pristine anode. However, it is higher than the efficiency of the previously recycled anode sample. This difference can be primarily attributed to the lesser degradation experienced by the latest sample due to fewer cycles. The lower coulombic efficiency of the recycled anode may be partly due to the presence of residual lithium in the recycled anode powder. These findings suggest that the recycling process is effective, but there may be room for further optimization to improve the coulombic efficiency.

Presented herein are effective methods for recycling anodes from battery cells, as described in multiple embodiments. The use of binder-free anodes from semi-solid electrodes offers a unique advantage by simplifying the anode powder separation process and reducing the overall cost of recycling. Advanced characterization methods described herein reveal that the morphology and bulk structure of the anode remain intact after cycling. This finding suggests the feasibility of directly regenerating anodes through a surface washing and drying process. Furthermore, described herein is a residue lithium removal process that does not include caustic acids such as HCl and H₂SO₄. This approach provides a more environmentally friendly and efficient pathway for the sustainable recycling of spent (i.e., EOL) lithium-ion battery (LIB) anodes. These advancements mark significant progress in the field of battery recycling.

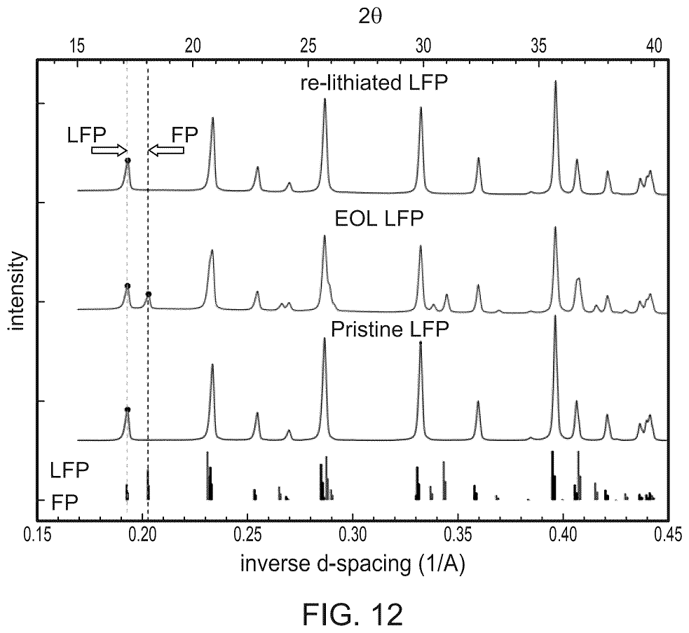

FIG. 12 shows XRD comparisons of EOL lithium iron phosphate (LFP) electrodes compared to pristine LFP electrodes and re-lithiated LFP electrodes. The disappearance of the FP phase (shown in FIG. 12) in the XRD pattern after re-lithiation indicates the successful conversion of EOL LFP to high purity LFP. This is further confirmed by almost identical XRD patterns of the re-lithiated LFP and the pristine LFP, suggesting that the re-lithiation process effectively restores the EOL LFP to its original state. Importantly, no impurity phase is identified in the XRD pattern of the re-lithiated LFP, underscoring the effectiveness of the re-lithiation process in producing high purity LFP. FIG. 12 demonstrates the potential of wet chemistry re-lithiation as a viable method for recycling EOL LFP.

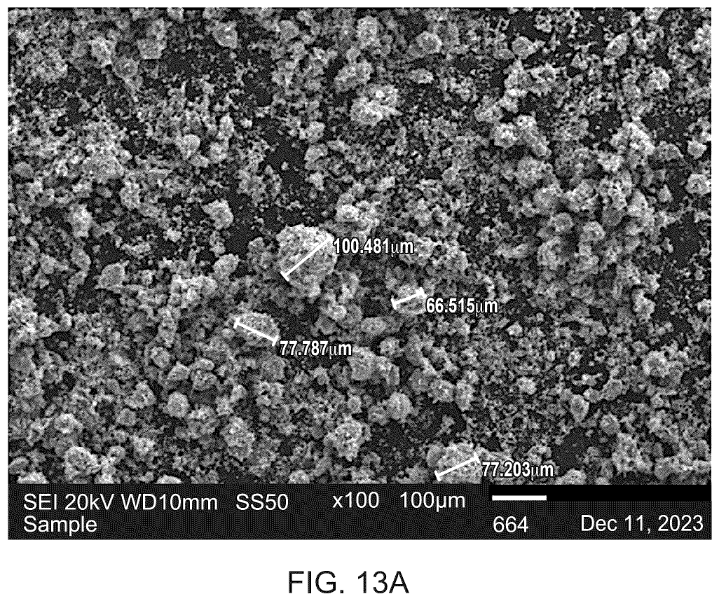

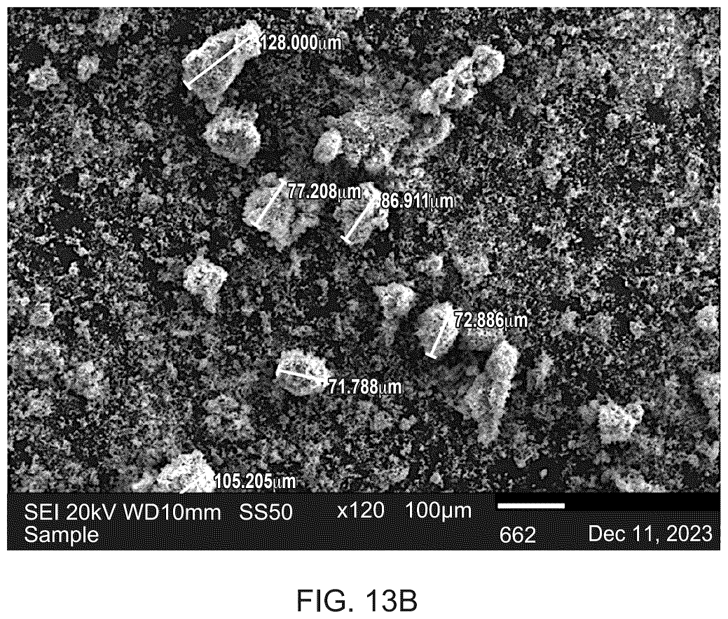

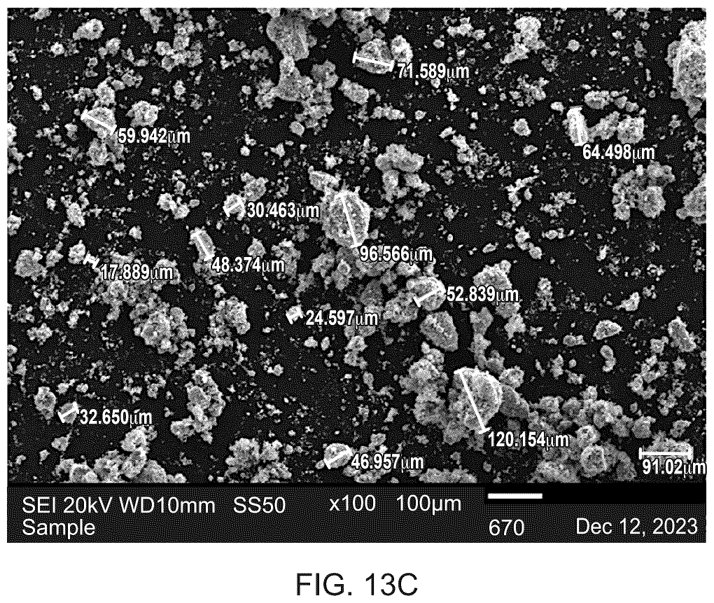

FIGS. 13A-13C display the SEM images of EOL LFP (FIG. 13A), pristine LFP (FIG. 13B), and re-lithiated LFP (FIG. 13C). Upon examination, no clear differences are observed in the SEM images between the EOL, pristine, and re-lithiated LFP, indicating that the re-lithiation process does not significantly alter the surface morphology of the particles. There might be some differences in particle size which could be attributed to agglomeration.

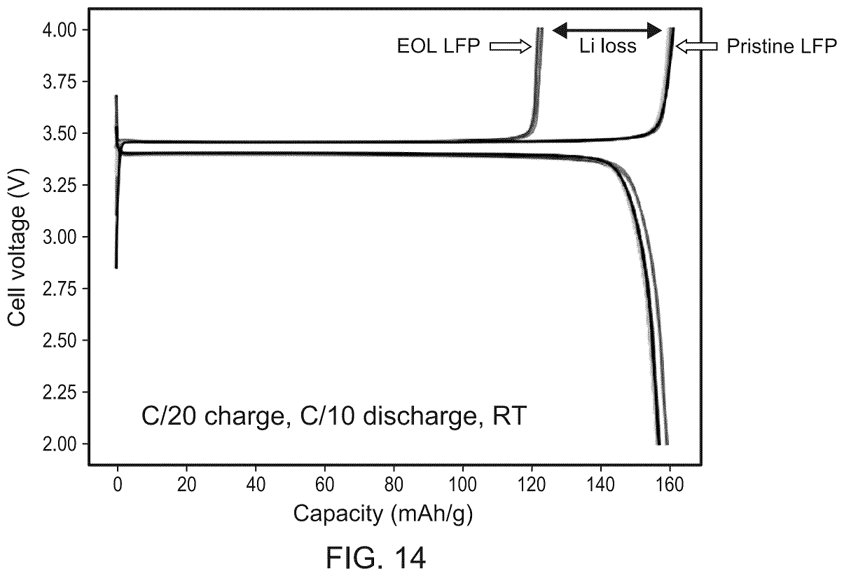

FIG. 14 is a graphical representation of a first cycle voltage profile of End-of-Life (EOL) Lithium Iron Phosphate (LFP) and pristine LFP, and provides a comparison of the first charge capacities between EOL LFP and pristine LFP, as measured in coin cells. The EOL LFP exhibits a first charge capacity of 123 mAh/g, which is notably lower than the 160 mAh/g capacity of the pristine LFP. This difference, representing a 23% lithium loss in the EOL LFP, is clearly indicated on the graph. The graph effectively visualizes the impact of lithium loss on the performance of the EOL LFP when compared to the pristine LFP. These findings underscore the importance of mitigating lithium loss in order to maintain the performance of LFP during its lifecycle.

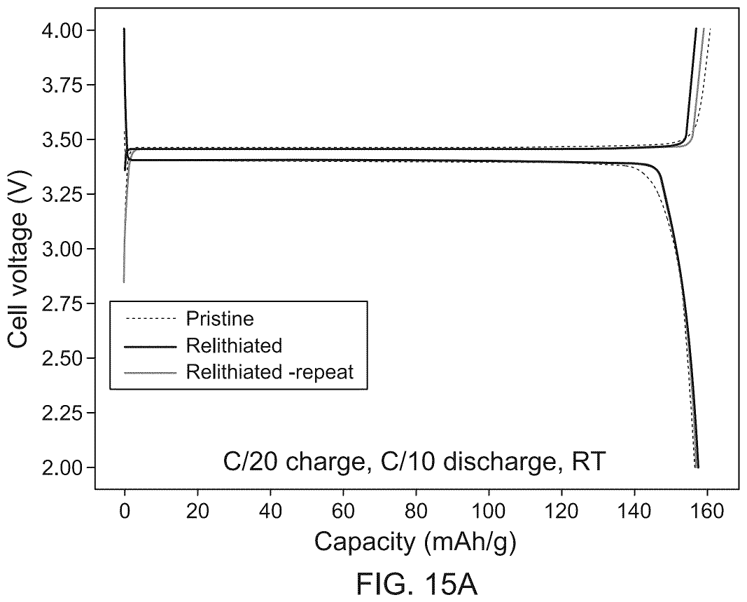

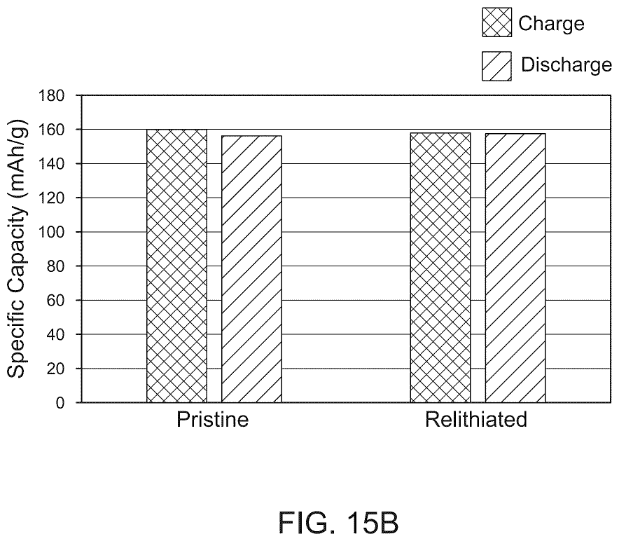

FIGS. 15A-15B show first cycle voltage profiles and capacity of relithiated LFP and pristine LFP. FIG. 15A presents a comparative analysis of the performance of pristine, relithiated, and relithiated-repeat LFP. The graph shown in FIG. 15A plots cell voltage (V) against capacity (mAh/g), with the cycle rate indicated by C/20 charge and C/10 discharge at room temperature (RT). The relithiated LFP, prepared through a wet chemistry process, shows excellent performance in the first cycle, achieving an average discharge capacity of 157 mAh/g at a C/10 rate. The consistent and stable performance of the relithiated LFP over multiple cycles, as shown in the graph, validates the success of the relithiation process in rejuvenating EOL LFP batteries. The preliminary results thus demonstrate the potential of relithiation as a viable strategy for enhancing the performance and extending the lifespan of LFP batteries. FIG. 15B compares the specific capacities of relithiated LFP and pristine LFP in both charge and discharge states. The relithiated LFP shows nearly 100% capacity recovery compared to pristine LFP.

FIG. 16 shows XRD comparisons of pristine anode material that includes graphite, EOL anode material (EOL graphite), recycled anode material after washing and heat treatment, and recycled anode material after washing, heat treatment, and 5% pitch coating. The XRD patterns are nearly identical which implies that each of these have similar crystal structures. Therefore, the recycling processes including washing, heat treatment and pitch coating do not affect the anode material's structure. A detailed analysis of the (002) peaks, representing the interlayer spacing in the graphite structure, shows (002) peak shift and broadening for recycled anode material which can be due to presence of less ordered carbon. This may also be due to the presence of residual lithium ions trapped within the graphite layers.

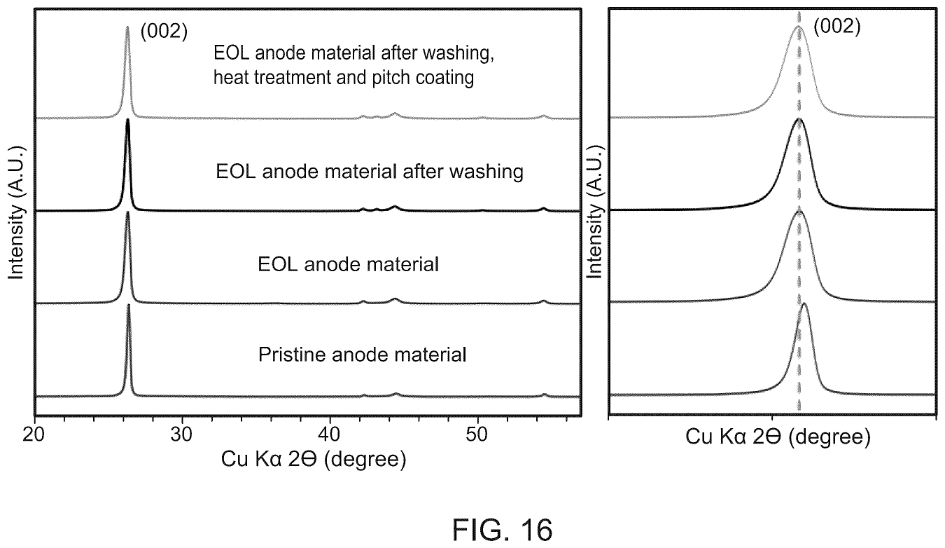

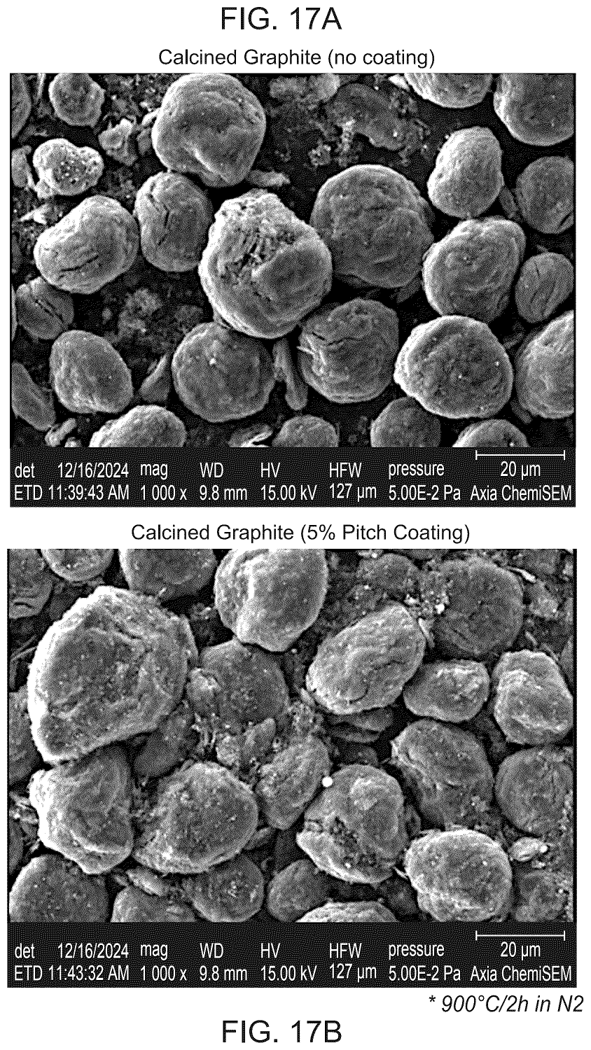

FIG. 17A-17B show SEM images of recycled anode material after heat treatment with and without pitch coating, respectively. The sample shown in FIG. 17B was coated with 5% pitch. Heat treatment was done at 900° C. for 2 hours in nitrogen gas. Comparison of SEM images show that the morphology of recycled anode material after pitch coating is not altered significantly. However, a subtle difference in particle surface roughness is observed which can be due to pitch diffusion in pores and microcracks.

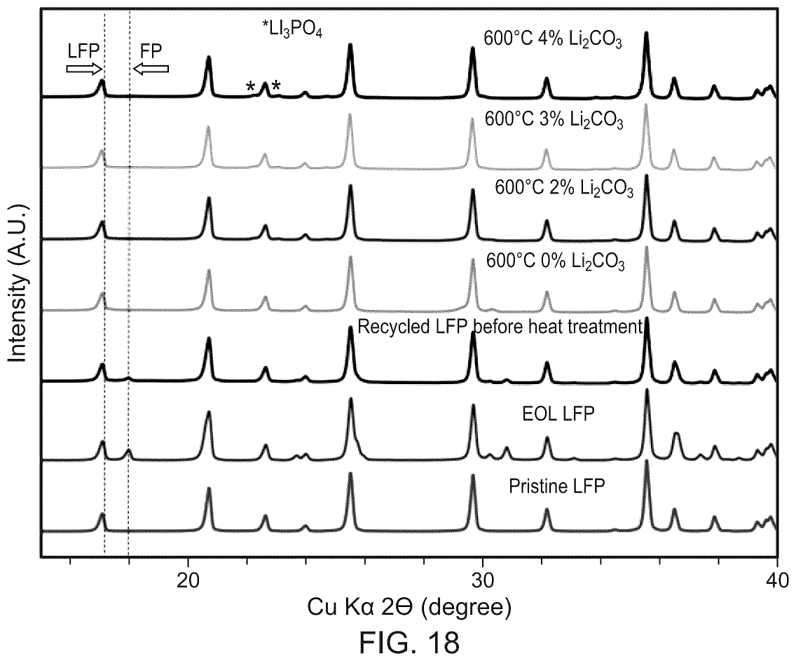

FIG. 18 shows XRD results for pristine LFP, EOL LFP, recycled LFP before heat treatment, LFP with heat treatment at 600° C. without lithium salt, LFP with heat treatment at 600° C. with 2% Li₂CO₃, LFP with heat treatment at 600° C. with 3% Li₂CO₃, and LFP with heat treatment at 600° C. with 4% Li₂CO₃. The small amount of FP phase in recycled LFP before heat treatment indicated incomplete reaction. The disappearance of the FP phase in the XRD pattern in FIG. 18 after heat treatment without Li₂CO₃ indicates the successful conversion of EOL LFP to high purity LFP. This is further confirmed by almost identical XRD patterns of the LFP after heat treatment and the pristine LFP, that heat treatment process effectively restores the EOL LFP to its original state. On the other hand, the impurity phase which is related to Li₃PO₄ with 4% Li₂CO₃ indicates excess Li₂CO₃. It shows that Li₂CO₃ should be lower than 4%.

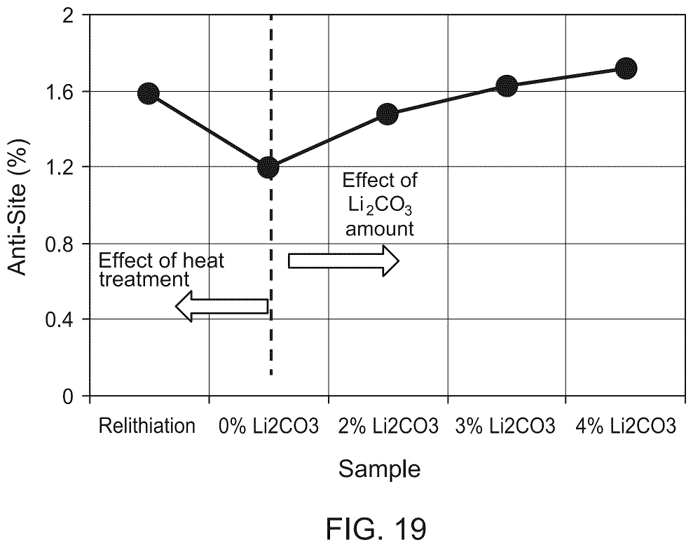

FIG. 19 shows the effect of heat treatment and percentage of Li₂CO₃ on anti-sites derived from XRD refinement. Heat treatment was done at 600° C. Anti-site is a defect in LFP that occurs when a transition metal ion occupies Li⁺ site in LFP. It can interfere with Lit diffusion and structural stability and block diffusion pathway. Therefore, it can lead to reduced capacity and increased resistance. The results shown in FIG. 19 indicate that the sample with 0% Li₂CO₃ after heat treatment has the lowest percentage of anti-sites. It suggests that heat treatment at high temperature and short time reduce the structural defects (anti-sites). FIG. 19 further indicates that excess Li₂CO₃ addition during the heat treatment process is not beneficial for anti-site removal.

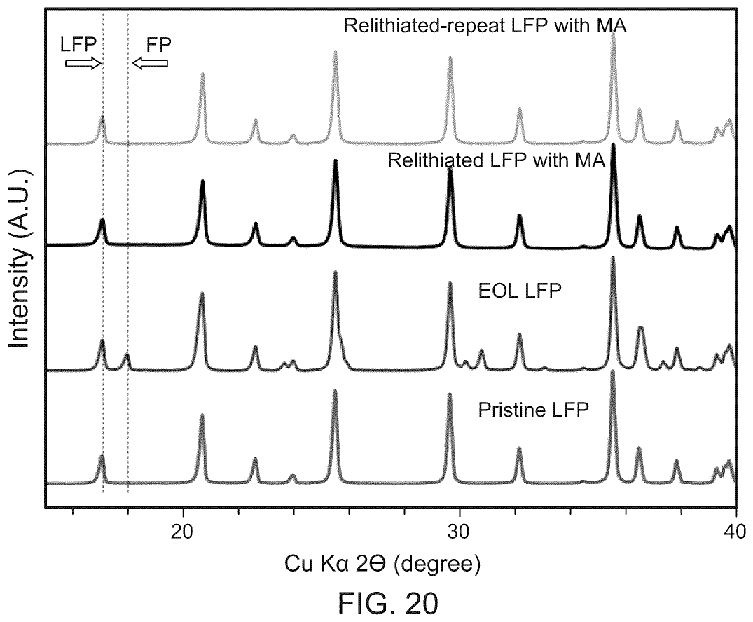

FIG. 20 shows XRD results for pristine LFP, EOL LFP, relithiated LFP with malic acid (MA), and relithiated-repeat LFP with malic acid (MA). Malic acid is a reducing agent used in wet chemistry relithiation process for cathode material regeneration (e.g., as described with respect to step 24 of the method 20 of FIG. 2). The disappearance of the FP phase in relithiated LFP with MA indicates successful relithiation and achieving substantially pure LFP, while also indicating that the relithiation process is repeatable.

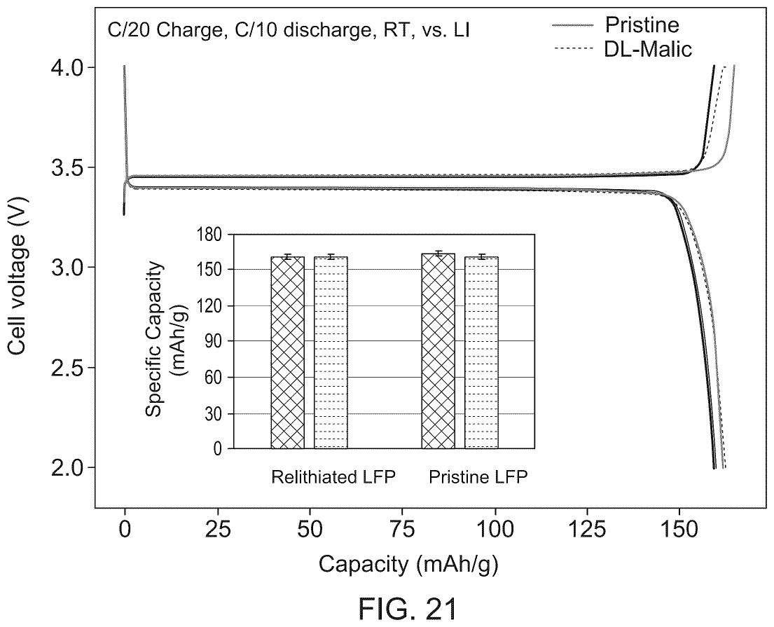

FIG. 21 is a graphical representation of first cycle voltage profiles and specific capacity of relithiated LFP with MA and pristine LFP. It presents a comparative analysis of the performance of pristine LFP and relithiated LFP with MA. The graph shown in FIG. 21 plots cell voltage (V) against capacity (mAh/g), with the cycle rate indicated by C/20 charge and C/10 discharge at room temperature (RT). The relithiated LFP with MA, as the reducing agent for wet chemistry relithiation, shows excellent performance in the first cycle. The consistent and stable performance of the relithiated LFP with MA over multiple cycles, as shown in the graph, validates the success of the relithiation process with MA in rejuvenating EOL LFP. The preliminary results thus demonstrate the potential of relithiation as a viable strategy for enhancing the performance and extending the lifespan of LFP batteries. The inset bar chart compares the specific capacities of relithiated LFP with MA and pristine LFP in both charge and discharge states. The relithiated LFP shows nearly 100% capacity recovery compared to pristine LFP.

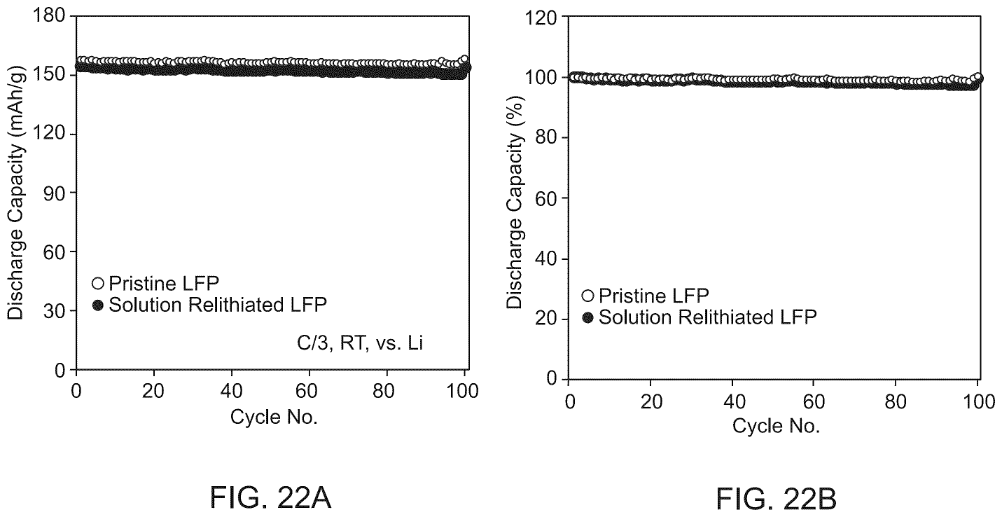

FIG. 22A-22B are schematic representations of cycling performance of recycled LFP. FIG. 22A presents discharge capacity (mAh/g) against cycle number for pristine and solution relithiated LFP at C/3 rate (discharge rate) and room temperature. FIG. 22B presents discharge capacity percentage (%) against cycle number for pristine and solution relithiated LFP. Solution relithiation is the process of relithiation in presence of a reducing agent. Results indicate that the solution relithiated LFP shows similar cycling performance as pristine LFP even after 100 cycles.

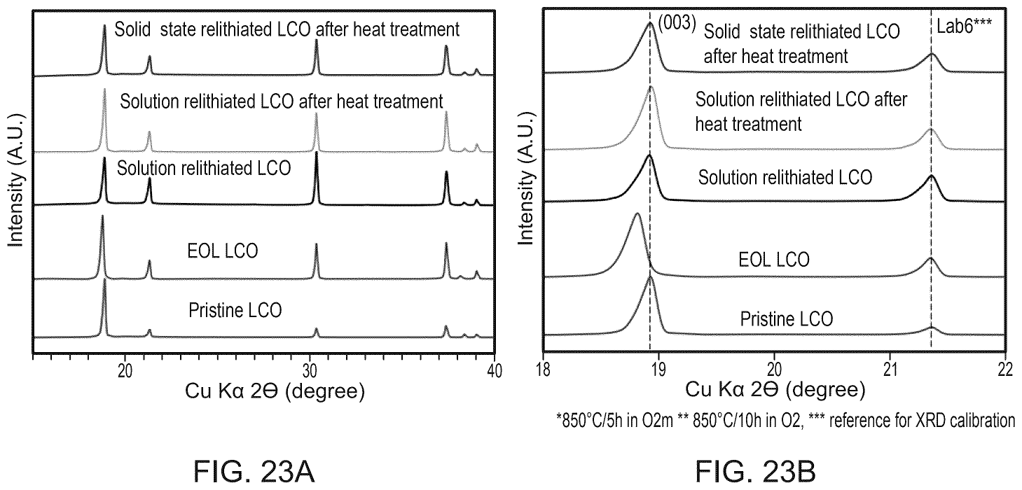

FIGS. 23A-23B show XRD results for pristine lithium cobalt oxide cathode (LCO), EOL LCO, solution relithiated LCO, solution relithiated LCO with heat treatment (at 850° C. for 5 hours in oxygen.), and solid state relithiated LCO (at 850° C. for 10 hours in oxygen). FIG. 23A shows the full spectrum XRD results while FIG. 23B is a focused near the (003) peak. LiCoO₂ is from the general family of LiMO₂ which can be used as a cathode material. Relithiated LCO with wet chemistry in presence of a reducing agent is called solution relithiated LCO. Solid state relithiated LCO is prepared through regeneration of cathode with adding lithium source with no solution. XRD pattern in FIG. 23B reveals (003) peak shift of relithiated LCO compared to EOL LCO. This indicates successful relithiation with solution relithiation process regardless of heat treatment as well as solid state relithiation process.

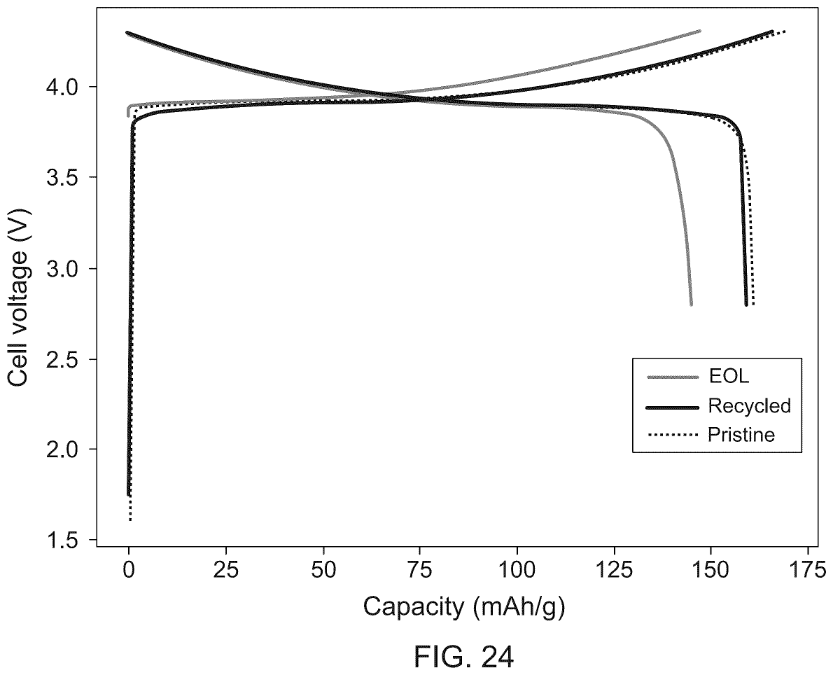

FIG. 24 is a graphical representation of first cycle voltage profiles of pristine LCO, EOL LCO and recycled LCO by a solid state relithiation process. Recycled LCO shows similar capacity compared to pristine LCO which validates the success of the relithiation process in rejuvenating EOL LCO batteries.

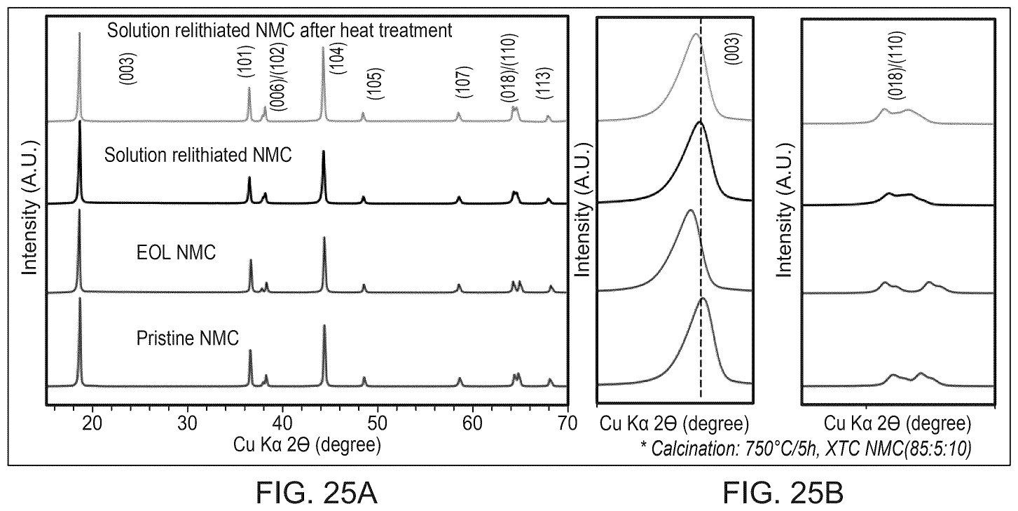

FIG. 25A-25B show XRD results for pristine NMC, EOL NMC, solution relithiated NMC, and solution relithiated NMC after heat treatment (at 750° C. for 5 hours). NMC is another material that can be used as cathode. FIG. 25A shows the full spectrum XRD results while FIG. 25B is a focused near (003) peak. The (003) peak shift of relithiated NMC compared to EOL NMC indicates successful relithiation. On the other hand, less splitting of (018)/(110) peaks indicate less crystallinity and structural degradation during recycling.

EOL active materials (anode and cathode) before and after regeneration were characterized by SEM, XRD, inductively coupled plasma (ICP) spectroscopy, particle size analysis, and electrochemical testing. For electrochemical testing, the active materials (anode or cathode) were mixed with binders (carboxymethyl cellulose (CMC) and Styrene-butadiene rubber (SBR)) for anode, PVDF for cathode) and conductive carbon black (e.g., Super C45) in appropriate solvent (DI water for anode, NMP for cathode) to form a slurry before and after recycling. The slurry was coated onto copper foil for anode or aluminum foil for cathode and dried in a vacuum oven. A 2032-type half-cell was assembled and tested in battery testers.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A method of recycling battery materials, the method comprising:
separating an anode material from a first cathode material and a first separator of a spent electrochemical cell;
washing the anode material;
drying the anode material to form a recycled anode material; and
combining the recycled anode material with a second cathode material and a second separator material to form a recycled electrochemical cell.

2. The method of claim 1, wherein the anode material includes a carbon-based anode material.

3. The method of claim 2, wherein the carbon-based anode material includes at least one of mesocarbon microbeads, artificial graphite, natural graphite, or hard carbon.

4. The method of claim 1, wherein the anode material includes a non-carbon-based anode material.

5. The method of claim 4, wherein the non-carbon-based anode material includes at least one of silicon, tin, SiO, SiO₂, SnO₂, antimony, TiO₂, lithium titanate (LTO).

6. The method of claim 1, wherein the anode material includes a blend of carbon-based and non-carbon-based anode materials.

7. The method of claim 6, wherein the non-carbon based anode materials include at least one of lithium metal, Si, SiO, Sn, Sb, SnO₂, SnS, SnS₂, Sn₃P₄, Bi, P, Sb₂O₃, Fe₂O₃, LTO, Al, Ag, Au, B, Mg, or In.

8. The method of claim 1, wherein separating the anode material from the first cathode material and the first separator is via at least one of ultrasonication, scraping, or vacuuming.

9. The method of claim 1, further comprising:
treating the anode material with a lithium removal agent;
filtering the anode material; and
collecting the anode material via at least one of filtering or centrifugation.

10. The method of claim 9, wherein the lithium removal agent includes at least one of biphenyl or naphthalene.

11. The method of claim 9, wherein the lithium removal agent is mixed with an organic solvent.

12. The method of claim 11, wherein the organic solvent includes at least one of a linear carbonate, a cyclic carbonate, a cyclic ether, an alcohol, dimethyl carbonate (DMC), dimethyl ether (DME), tetrahydrofuran (THF), methyl acetate (MA), ethyl acetate (EA), ethyl methyl carbonate (EMC), diethyl carbonate (DEC, acetonitrile (ACN), isopropyl alcohol (IPA), or N-methylpyrrolidone (NMP).

13. The method of claim 1, wherein washing the anode material is via organic solvents and water, such that the washing removes electrolyte from the anode material.

14. The method of claim 1, wherein the drying includes a first phase and a second phase, the first phase at a temperature of about 60° C. to about 80° C. for a period of about 10 hours to about 14 hours, the second phase at a temperature of about 80° C. to about 250° C. for a period of about 10 hours to about 14 hours.

15. The method of claim 14, further comprising:
adding a surface modifier to the recycled anode material, the surface modifier including at least one of boron, titanium, tungsten, carbon, TiO, TiOₓ, WₓO_{y}, LiₓB_{y}O_{z}, or any combination thereof, wherein x, y, and z are integers.

16. The method of claim 15, further comprising:
forming the surface modifier by mixing precursors and graphite in a slurry or in a dry mixing phase; and
heating the graphite and precursors to decompose the precursors.

17. The method of claim 16, wherein the precursors include at least one of boric acid, an alkoxide, titanium isopropoxide, tungsten (IV) ethoxide, or pitch.

18. A method of recycling battery materials, the method comprising:
separating a cathode material from an anode material and a separator of a spent electrochemical cell;
washing the cathode material;
drying the cathode material to form a cathode powder; and
regenerating the cathode powder to form a regenerated cathode material.

19. The method of claim 18, wherein the cathode material is binderless.

20. The method of claim 18, wherein the cathode material includes at least one of a layered oxide, a spinel oxide, or a polyanion oxide.

21. The method of claim 20, wherein the cathode material is subject to at least one of a doping or a surface treatment.

22. The method of claim 18, wherein separating the cathode material from the anode material and the separator is via at least one of ultrasonication, scraping, or vacuuming.

23. The method of claim 18, wherein the washing is via at least one of an organic solvent or water.

24. The method of claim 23, wherein the organic solvent includes at least one of a linear carbonate, a cyclic carbonate, a cyclic ether, an alcohol, dimethyl carbonate (DMC), dimethyl ether (DME), tetrahydrofuran (THF), methyl acetate (MA), ethyl acetate (EA), ethyl methyl carbonate (EMC), diethyl carbonate (DEC), acetonitrile (ACN), isopropyl alcohol (IPA), or N-methylpyrrolidone (NMP).

25. The method of claim 18, wherein the drying includes a first phase and a second phase, the first phase at a temperature of about 60° C. to about 80° C. for a period of about 10 hours to about 14 hours, and the second phase at a temperature of about 80° C. to about 250° C. for a period of about 10 hours to about 14 hours.

26. The method of claim 18, wherein regenerating the cathode powder includes at least one of solid state relithiation, wet chemistry relithiation, or acid leaching and re-synthesis.

27. The method relithiation of claim 26, wherein the wet chemistry relithiation includes a relithiation solution, the relithiation solution including an aqueous solution that comprises a lithium salt and a reducing agent.

28. The method of claim 26, wherein the wet chemistry relithiation includes a relithiation solution, the relithiation solution including a nonaqueous solution that comprises a lithium salt and an organic solvent.

29. The method of claim 28, wherein the lithium salt is selected from the group consisting of LiOH, LiCl, LiNO₃, Li₂SO₄, and LiC₂H₃O₂.

30. The method of claim 27, wherein the reducing agent comprises organic acids including at least one of citric acid, acetic acid, formic acid, glycolic acid, carbonic acid, oxalic acid, malonic acid, maleic acid, malic acid, ascorbic acid, lactic acid, tartaric acid, butyric acid, folic acid, or uric acid.

31. The method of claim 27, wherein the reducing agent comprises an alcohol.

32. The method of claim 27, wherein the reducing agent comprises a glycol.

33. The method of claim 27, wherein the reducing agent comprises at least one of boron hydride or hydrazine hydrate.

34. The method of claim 27, wherein the relithiation is performed in a range of about 60° C. to about 100° C., for a relithiation duration in a range of about 1 hour to about 48 hours.

35. The method of claim 28, wherein the lithium salt comprises at least one of lithium naphthalene and lithium biphenyl.

36. The method of claim 28, wherein the organic solvent includes at least one of a linear carbonate, a cyclic carbonate, a cyclic ether, an alcohol, dimethyl carbonate (DMC), dimethyl ether (DME), tetrahydrofuran (THF), methyl acetate (MA), ethyl acetate (EA), ethyl methyl carbonate (EMC), diethyl carbonate (DEC, acetonitrile (ACN), isopropyl alcohol (IPA), or N-methylpyrrolidone (NMP).

37. The method of claim 28, wherein the relithiation is performed at temperature in a range of about 0° C. to about 50° C., for a relithiation time in a range of about 1 minute to about 120 minutes.

38. A method of forming a recycled electrochemical cell, the method comprising:
separating a first anode material and a first cathode material from a first separator, the first anode material, the first cathode material, and the first separator included in a first electrochemical cell;
exposing a second electrochemical cell to at least one of a leaching solvent or a lithium removal solvent to form a lithium-rich liquid;
washing the first anode material;
drying the first anode material to form a recycled anode material;
mixing lithium metal from the lithium-rich liquid with the first cathode material to form a regenerated cathode material; and
combining the recycled anode material with the regenerated cathode material and a second separator to form a recycled electrochemical cell.

39. The method of claim 38, wherein the first cathode material is binderless.

40. The method of claim 38, wherein the lithium removal solvent includes at least one of biphenyl or naphthalene.

41. The method of claim 38, wherein the first cathode material is subject to at least one of a doping or a surface treatment.
